(19) United States
(12) Patent Application Publication
(10) Pub. No.: US 2023/0162929 A1
(43) Pub. Date: May 25, 2023

(54) INPUT DEVICES WITH MULTI-DIRECTIONAL INPUT CAPABILITIES

(71) Applicant: Apple Inc., Cupertino, CA (US)

(72) Inventors: Steven J. Taylor, San Jose, CA (US); Megan A. McClain, Napa, CA (US); Brenton A. Baugh, Teddington (GB); Benjamin G. Jackson, Piedmont, CA (US)

(21) Appl. No.: 17/975,375

(22) Filed: Oct. 27, 2022

Related U.S. Application Data
(60) Provisional application No. 63/281,541, filed on Nov. 19, 2021.

(51) Int. Cl. H01H 13/14; H01H 13/20; H01H 13/10

(52) U.S. Cl. CPC H01H 13/14; H01H 13/20; H01H 13/10; H01H 2215/00

(57) ABSTRACT

Described herein are input devices for registering a translational input as a button is moved along any of a first set of different directions. In general, the input devices comprise a switch assembly including a switch that is actuated as the button moves along the first set of directions. The switch assembly may include additional components, such as a rotatable member or a cavity that are configured to engage the switch to actuate the switch. The switch assembly may be configured to provide a uniform pressing experience when moving the button along the first set of different directions.

### CROSS-REFERENCE TO RELATED APPLICATIONS

This application claims the benefit under 35 U.S.C. § 119(e) of U.S. Provisional Patent Application No. 63/281,541, filed Nov. 19, 2021, the contents of which are incorporated herein by reference in their entirety.

### FIELD

The present disclosure relates generally to electronic devices and, more specifically, to input devices for electronic devices.

### BACKGROUND

Many types of electronic devices, such as smart phones, tablets, gaming devices, computers, wearables, and the like, use input devices, such as dials, buttons, or switches, to receive input from a user. Many of these input devices may allow for translational and/or rotational inputs (each of which may be used by an associated electronic device to impact operation of the electronic device), but translational inputs are generally limited to a single direction of movement. For example, a button may be pressed in a single direction to receive a user input. Alternatively, a dial (such as a crown on a watch) may be rotated to receive a rotational input and may be pressed in a single direction (like a button) to receive a translational input. It may be desirable to provide input devices that allow a user increased flexibility in providing input to an electronic device.

### SUMMARY

Described here are input devices that include buttons moveable by a user in multiple directions to register a translational input. In general, the input devices comprise a button that is moveable along any of a first set of different directions. The button may also be moveable in an additional direction that is perpendicular to each of the first set of different directions and/or rotatable around an axis of rotation. Movement in the additional direction may also be registered as a translational input, while rotation around the axis of rotation may be registered as a rotational input.

Some embodiments may include an input device comprising a housing, a button moveable relative to the housing in a first set of different directions, and a switch assembly that includes a cavity surface defining a cavity and a first switch. Movement of the button in any of the first set of different directions creates relative movement between the cavity surface and the first switch, thereby actuating the first switch and registering a first translational input. In some variations, the button is moveable relative to the housing in an additional direction that is perpendicular to the first set of different directions. The first switch may be a tactile switch.

In some of these embodiments, the switch assembly further comprises an intermediate component positioned between the cavity surface and the first switch, and the switch assembly is configured such that the relative movement between the cavity surface and the first switch moves the intermediate component toward the first switch. In some of these variations, the input device comprises a stationary component and the intermediate component is constrained to move in a single direction relative to the stationary component. Additionally or alternatively, the intermediate component is a magnetic intermediate component.

The switch assembly may be configured such that the first switch pivots during the relative movement between the cavity surface and the first switch. In some of these variations, the cavity surface comprises a first magnet arrangement and the first switch comprises a second magnet arrangement. The first magnet arrangement attracted is attracted to the second magnet arrangement during the relative movement between the cavity surface and the first switch.

Other embodiments may include an input device comprising a housing, a button moveable relative to the housing in a first set of different directions, and a switch assembly that comprises a rotatable member and at least one switch. The rotatable member is rotatable and translatable relative to a pivot point, and the switch assembly is configured such that the movement of the button in any of the first set of different directions causes the rotatable member to move relative to the pivot point, thereby actuating the at least one switch. The at least one switch comprises multiple switches, and in some of these instances the multiple switches comprise a first switch and a second switch. In these variations, the switch assembly is configured such that the first switch is actuated when the rotatable member translates toward the first switch, and the second switch is actuated when the rotatable member rotates in a first direction. The multiple switches may further comprise a third switch, where the third switch is actuated when the rotatably member rotates in a second direction opposite the first direction.

Additionally or alternatively, the switch assembly comprises one or more springs connecting the rotatable member to a stationary component. The rotatable member may further comprise a proximal contact surface facing the button, and the movement of the button in any of the first set of different directions causes the button to apply a force to the proximal contact surface. Additionally or alternatively, the button is rotatable around a rotational axis, the input device registers a rotational input when the button rotates around the rotational axis, and the first rotational axis is perpendicular to the first set of different directions.

Yet other embodiments may include an input device comprising a housing, a button moveable relative to the housing in a first set of different directions, and a switch assembly that comprises a rotatable linkage and a set of switches. The button is slidably coupled to the rotatable linkage and the movement of the button in any of the first set of different directions moves the button relative to the rotatable linkage, thereby actuating at least one switch of the set of switches. The rotatable linkage may be rotatable around a pivot point and, in some of these embodiments, the pivot point is slidable relative to a stationary component of the input device. Additionally or alternatively, the button may comprise a post that is slidably positioned within a first track defined in the rotatable linkage. In some of these embodiments the set of switches comprises a first switch positioned in the first track. Optionally, the at least one switch further comprises a second switch positioned in the first track.

In addition to the exemplary aspects and embodiments described above, further aspects and embodiments will become apparent by reference to the drawings and by study of the following description.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows an example schematic diagram of an electronic device that may utilize one or more of the input devices described herein.

FIG. 2A shows a top view of a such variation of a button suitable for use with the input devices described herein. FIGS. 2B-2E show cross-sectional side views of input devices that may incorporate the button of FIG. 2A.

FIG. 3 shows a cross-sectional side view of an illustrative variation of an input device including a button as described herein.

FIGS. 4A and 4B show cross-sectional side views of an illustrative variation of an input device including a rotation member.

FIGS. 5A-5F show cross-sectional side views and FIG. 5G shows a top view of variations of input devices that have switch assemblies including a switch and a surface that defines a cavity.

FIGS. 6A-6G show cross-sectional side views of variations of input devices that have switch assemblies that include a switch and a surface that defines a cavity, where the switch rotates with relative movement between the switch and the cavity.

FIG. 7 shows a cross-sectional side view of a variation of an input device including a magnetic intermediate member.

FIGS. 8A-8C show cross-sectional side views of input devices having magnet assemblies.

FIG. 9A shows a cross-sectional side view and FIGS. 9B and 9C show cross-sectional top views of a variation of an input device utilizing a rotatable linkage. FIGS. 9D and 9E show cross-sectional side and cross-sectional top views, respectively, of another variation of an input device utilizing a rotatable linkage.

FIGS. 10A and 10B show cross-sectional side views of a variation of an input device utilizing a rotatable linkage.

FIGS. 11A and 11B show a cross-sectional side view and a cross-sectional top view, respectively, of an input device including an annular dome switch.

It should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

Described herein are input devices configured to receive an input from a user. In some embodiments, the input devices comprise a button, where at least a portion of the button is moveable in a first set of different directions, and may be configured to register a first translational input when the button (or a portion thereof) is moved along any of these different directions. For the purpose of this application, when a component is discussed as being configured to move in “a set of different directions,” or “different directions,” the component is configured to move along two or more non-parallel directions (i.e., the component moves in two or more dimensions). In other words, movement of a component back and forth along a common axis would not be considered movement in different directions.

Generally, all of the first set of different directions are coplanar, which may allow the button to be moved in multiple directions in a common plane. While in some instances the button is constrained to move only one of the first set of different directions at a time (i.e., the button is constrained to move within the common plane), it should be appreciated that in other instances that the button also simultaneously moves along an additional direction that is perpendicular to the first set of different directions. In these instances, the button is actually moving in a third direction represented by a vector having a first component along a direction of the first set of different directions and a second component along the additional direction. For the purpose of this application, the button is considered to move along a given direction so long as a vector component of the button's movement is parallel to the given direction. In other words, so long as a portion of the button moves along one of the first set of different directions (i.e., by a threshold amount needed to actuate a switch, as discussed below), the button (or portions thereof) may also rotate, pivot, or otherwise move in the additional direction.

Additionally, in some instances, the button may be further configured to function as a dial and rotate around a rotational axis to register a first rotational input. In these variations, the rotational axis is typically perpendicular to each of the first set of directions (e.g., perpendicular to the common plane in which the first set of different directions lie). Additionally or alternatively, and as mentioned above, the button may also be able to move in an additional direction that is perpendicular to each of the first set of different directions (e.g., perpendicular to the common plane of the first set of different directions). In instances where the button is configured to rotate around a rotational axis, this additional direction may be parallel to the rotational axis. Movement along the additional direction may also register as a translational input to an associated electronic device and, depending on the design on the input device, may be treated as the same as translational input registered from movement along one of the first set of different directions (i.e., it is treated as the first translational input) or may be treated as a different translational input (i.e., a second translational input).

By allowing a translational input to be registered from movement along any of a first set of different directions, the input devices described herein may make it easier for a user to provide an input to a button. A traditional button can only register a translational input as the button is depressed (or otherwise translated) in a single direction, which may be inconvenient for a user in certain instances. For example, when the button forms a crown for a watch, a user may need to move their hand to a particular position in order to properly press the button. By contrast, a button that can be translated in multiple different directions to register a translational input may allow a user to provide the input from a wider range of possible positions.

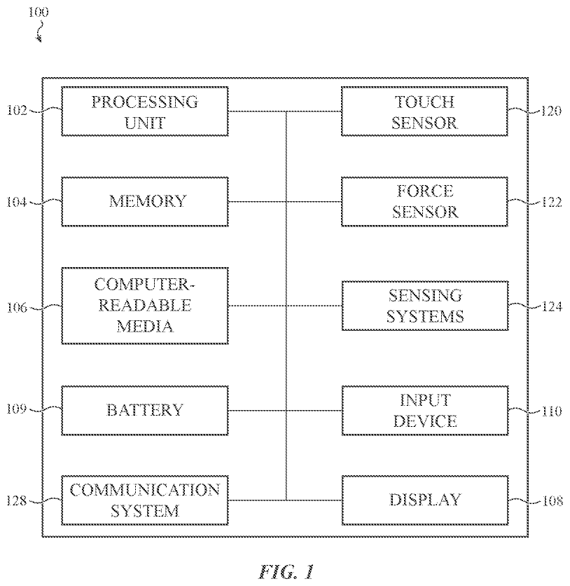

These and other embodiments are discussed below with reference to FIGS. 1-11B. However, those skilled in the art will readily appreciate that the detailed description given herein with respect to these Figures is for explanatory purposes only and should not be construed as limiting.

The input devices described herein may be used with any suitable electronic device, including, but not limited to, mobile telephones (e.g., smart phones), computers, tablets, gaming devices, wearable devices (e.g., smart watches, head-mounted devices), electronic systems of a vehicle, peripherals thereof (e.g., keyboards, controllers), or the like. FIG. 1 depicts an example schematic diagram of an electronic device 100 that may utilize one or more of the input devices described herein. It should be appreciated that this is merely an illustrative example of an electronic device 100, and that the input devices described herein may be used with electronic devices that do not include some of the functionality described herein with respect to electronic device 100 of FIG. 1.

As shown in FIG. 1, electronic device 100 includes a processing unit 102 operatively connected to computer memory 104 and/or computer-readable media 106. The processing unit 102 may be operatively connected to the memory 104 and computer-readable media 106 components via an electronic bus or bridge. The processing unit 102 may include one or more computer processors or microcontrollers that are configured to perform operations in response to computer-readable instructions and may use inputs registered by the input devices described herein in performing these operations. The processing unit 102 may include the central processing unit (CPU) of the device. Additionally or alternatively, the processing unit 102 may include other processors within the device including application specific integrated chips (ASIC) and other microcontroller devices.

The memory 104 may include a variety of types of non-transitory computer-readable storage media, including, for example, read access memory (RAM), read-only memory (ROM), erasable programmable memory (e.g., EPROM and EEPROM), or flash memory. The memory 104 is configured to store computer-readable instructions, sensor values, and other persistent software elements. Computer-readable media 106 also includes a variety of types of non-transitory computer-readable storage media including, for example, a hard-drive storage device, a solid-state storage device, a portable magnetic storage device, or other similar device. The computer-readable media 106 may also be configured to store computer-readable instructions, sensor values, and other persistent software elements. The processing unit 102 is operable to read computer-readable instructions stored on the memory 104 and/or computer-readable media 106. The computer-readable instructions may be provided as a computer-program product, software application, or the like, and may utilize user inputs received by the input devices described herein during operation.

As shown in FIG. 1, the electronic device 100 also includes a display 108. The display 108 may include a liquid-crystal display (LCD), an organic light emitting diode (OLED) display, a light emitting diode (LED) display, or the like. The electronic device 100 may also include a battery 109 that is configured to provide electrical power to the components of the electronic device 100, although it should be appreciated that electronic device 100 may be powered by an external power source (such as AC power) via power management circuitry.

In some embodiments, the electronic device 100 includes one or more input devices 110 configured to receive user input. The one or more input devices 110 include at least one of the input devices described here, but may also include one or more additional input devices, such as, for example, a rotatable input system, a push button, a touch-activated button, a keyboard, a keypad, or the like (including any combination of these or other components). The electronic device 100 may further comprise a touch sensor 120 (configured to determine a location of a touch on a touch-sensitive surface) and/or a force sensor 122 (configured to detect the magnitude of a force applied to a user input surface). The touch sensor 120 and/or force sensor 122 may be integrated with one or more layers of a display stack (e.g., the display 108, FIG. 1) to provide the touch- and/or force-sensing functionality, respectively, of a touchscreen.

The electronic device 100 may also include one or more sensing systems 124. Sensing systems 124 may include systems for sensing various different characteristics, parameters, and/or environments of or related to the electronic device 100. One example sensing system 124 is one or more motion sensing systems configured to detect and/or measure motion of the electronic device 100. For example, sensing systems 124 may include or use accelerometers, altimeters, moisture sensors, inertial measurement units, spatial sensors, cameras, ambient light sensors, gyroscopic sensors, global positioning systems, optical motion sensing systems (e.g., cameras, depth sensors, etc.), radar systems, LIDAR systems, or the like. Additionally or alternatively, sensing systems 124 may also include a biometric sensor, such as a heart rate sensor, an electrocardiograph sensor, a temperature sensor, or any other type of sensor.

The electronic device 100 may further include communication systems 128 that are configured to transmit and/or receive signals or electrical communication from an external or separate device. The communication systems 128 may be configured to couple to an external device via a cable, an adaptor, or other type of electrical connector, or via one or more wireless communication protocols (Bluetooth, Wi-Fi, cellular communications, etc.). The communication systems 128 may facilitate the communication of user input or other information between the electronic device 100 and other external devices.

As mentioned above, the input devices described herein are able to register a first translational input when a button of the input device is moved along any of a first set of different directions. Typically, each of the first set of different directions is positioned within a common plane (i.e., all of these directions are coplanar). In some instances, the button may also be moveable in an additional direction that is perpendicular to the first set of directions, and the input device may register a translational input (which may be treated the same as the first translational input, or as a different second translational input) when the button is moved along the additional direction. Additionally or alternatively, the button may be configured to function as a dial that is rotatable around a rotational axis to register a rotational input.

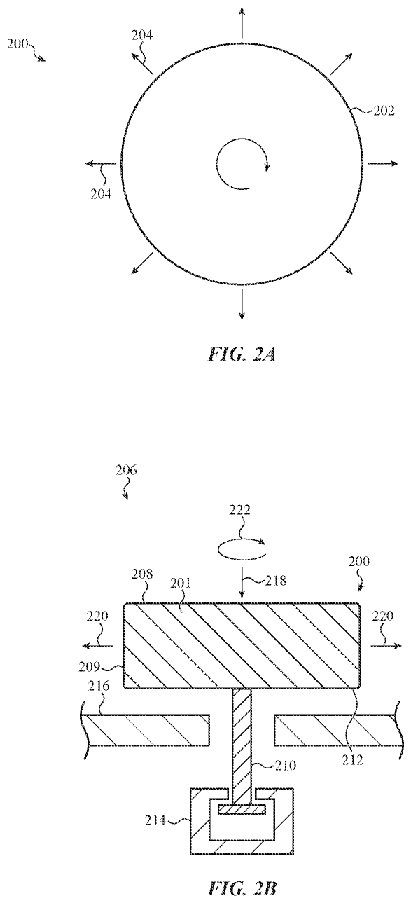

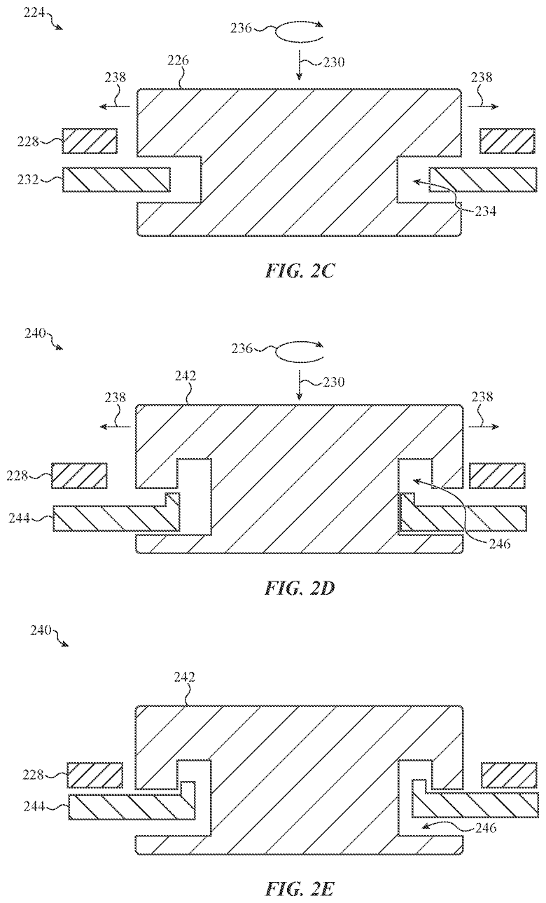

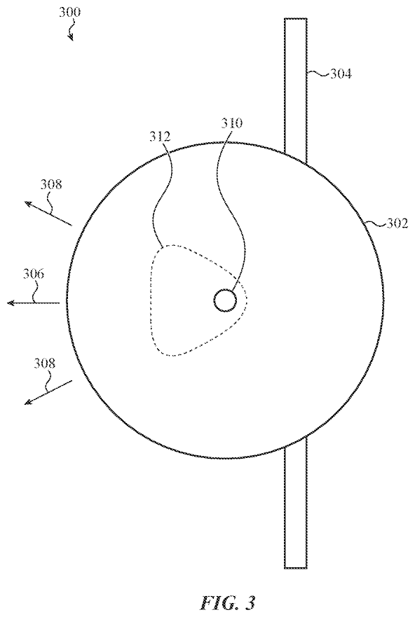

There are several possible ways in which an input device may be configured to allow a button to move in multiple different directions (and, in instances where the button functions as a dial, to rotate), but for the purpose of illustration, FIGS. 2A-2E and FIG. 3 show different variations of input devices with buttons that may be moved in multiple directions; such buttons may be suitable for use with the various embodiments of input devices described herein. It should be appreciated that the input devices described herein may be designed in any suitable manner to allow for movement of a button along a set of different directions (as well as to rotate around a rotational axis and/or move along an additional direction), as will be readily understood by one of ordinary skill in the art. For example, a button may slide or otherwise move along a variety of tracks, pivot about a pivot point or pivot axis, move freely within a constrained area, and so on, in order to provide movement in a number of different directions.

The button extends from (and in some instances extends through) a housing along a first direction. In some instances, the first set of different directions is perpendicular to this first direction. This may allow the button to move laterally relative to the housing in multiple different directions (e.g., the first set of different directions are each “lateral” directions) and register movement along some or all of these lateral directions as a first translational input. In some instances, the button may optionally also be moveable along the first direction (which would be considered movement along the “additional direction” described above), which may also be used to register a translational input. Additionally or alternatively, the button may be configured to rotate around a rotational axis that is parallel to the first direction. In these instances, the rotation may be registered as a rotational input, thereby allowing the button to act as a dial.

For example, FIG. 2A shows a top view of one such variation of a button 200 that may be incorporated into the input devices described herein. Button 200 is rotatable around a rotational axis (as indicated by curved arrow 202), and also may be moved in a first set of different directions (as indicated by arrows 204), each of which may be perpendicular to the rotational axis. This movement allows the button to receive (and the input device to register) both a translational input along any of first set of different directions and a rotational input. When the input devices described herein are discussed as using rotation of a button around a rotational axis to register a rotational input, it should be appreciated that the input device may be configured to measure the rotation of the button using any suitable technique, which will be readily understood by those of ordinary skill in the art. As one non-limiting example, a magnet may be coupled to or otherwise integrated into a portion of the button, and the input device may comprise a magnetic field sensor that tracks the magnet as it moves during rotation. In another non-limiting example, the button may comprise a pattern (e.g., a series, set or other pattern of light and dark marks, stripes, or the like, or areas of varying reflectance, polish, and so on) and the input device may comprise an optical sensor that may measure the change in pattern as the button rotates.

FIG. 2B shows a cross-sectional side view of one variation of an input device 206 that incorporates button 200. As shown, button 200 includes a cap 201 and a stem 210 extending from the cap 201. The cap 201 and stem 210 may be formed as a single monolithic piece or may be formed separately and attached to fix the stem 210 relative to the cap 201. The cap 201 may form one or more exterior surfaces (such as an outer surface 208 and an outer sidewall 209 as shown in FIG. 2B) either or both of which are positioned to receive a user input, and one or more interior surfaces (e.g., inner surface 212). As shown in FIG. 2B, a proximal end of the stem 210 extends from (and may be integrally formed with, affixed to, or joined with) the inner surface 212 of the cap 201. The input device 206 may comprise a sleeve 214, and a distal portion of the stem 210 extends into a sleeve 214 along a first direction 218 (which may be parallel to the axis of rotation of the button 200); this portion may be a stem cap that has a greater cross-sectional diameter than an immediately adjacent portion of the stem 210. The sleeve 214 may at least partially encircle and/or capture a portion of the stem 210 (such as a stem cap) and may constrain certain relative movement between the sleeve 214 and the stem 210.

As one non-limiting example, the input device comprises a housing 216, and in some variations the sleeve 214 may be fixed relative to the housing 216, which may in turn limit relative movement between a distal end of the stem 210 and the housing 216. When a lateral force (i.e., a force that, when exerted, causes the button to move in one of the first set of different directions, such as indicated by arrows 220) is applied to an outer surface 208 of the button 200, the stem 210 may bend to allow the button 200 to move in one of the first set of directions. In these instances, the bending of the stem 210 may cause the button cap 201 to pivot and move slightly toward the housing 216 as it moves in one of the first set of directions, although it should be appreciated that in some instances the buttons described herein may be configured such that the button (or a portion thereof) is capable of translating along any of the first set of different directions without otherwise moving in an additional direction that is perpendicular to the first set of different directions (such as the embodiments described below with respect to FIGS. 2C-2E and 3).

Depending on the direction of the force applied, the button 200 may be capable of laterally moving in any radial direction from a neutral position (e.g., a position at which the button rests when not otherwise acted upon by an external force), and thus the button may facilitate a 360 degree range of lateral movement that may be registered as a first translational input (although it should be appreciated that the input device 206 may be configured to restrict lateral movement of the button 200 to a subset of radial directions if so desired).

The button 200 may be biased toward the neutral position (e.g., the shaft may be elastically deformed when bent and/or may include one or more additional components such as a spring that actively biases the button 200 to the neutral position), such that movement of the button 200 along any of the first set of different directions is reversed when any external forces are removed. While discussed above as being stationary relative to the housing 216, in other variations, the sleeve 214 may be laterally moveable relative to the housing 216 (i.e., also moveable along the first set of different directions), such that the sleeve 214 moves laterally with the button 200 when a lateral force is applied to the button 200. In these instances, the stem 210 may also bend to increase the distance traversed by the cap 201 as compared to the distance traversed by the sleeve 214.

When an input device is described herein as having a housing, it should be appreciated that the housing need not completely enclose the other components of the input device, so long as a portion of the button is positioned external to the housing (i.e., to allow a user to interact with the button). In some instances, the input device is assembled as a standalone unit that is integrated into an enclosure of an electronic device. In some of these variations, the housing of the input device is connected to a first portion of the enclosure when the input device is integrated into the electronic device, such that the housing of the input device acts as a second portion of the enclosure (e.g., the first and second portions of the enclosure connect to form a continuous wall). In others of these variations, the housing of the input device does not form a portion of the enclosure and, instead, the enclosure of the electronic device encloses the housing of the input device. In still other variations, an input device can be integrally formed as part of the enclosure of the electronic device, in which case the enclosure of the electronic device is also the housing of the input device (e.g., a single structure may act as both the enclosure of the electronic device and the housing of the input device).

Returning to FIG. 2B, in instances where it is desirable for the button 200 to act as a dial, the input device 206 may be configured such that the button 200 is able to rotate (e.g., around a rotational axis which may be parallel to the first direction 218, with the rotation indicated by curved arrow 222). In these instances, the stem 210 is configured to rotate relative to the sleeve 214, thereby allowing the button 200 to rotate relative to the housing 216. Additionally, the button 200 may further be configured to move along the first direction 218 relative to the sleeve 214, which causes the stem 210 to extend further into the sleeve 214. In some instances, the sleeve 214 may provide a stop that limits how far the button 200 may be pressed along the first direction 218. This movement along the first direction 218 may also be registered as a translational input, such as discussed in more detail above.

In instances where a button of the input devices described herein is able to move along both a first set of different directions and an additional direction that is parallel along the first direction and a set of directions perpendicular to the first direction, the input device may either be configured such that these movements can occur simultaneously or configured such that movement along the additional direction is decoupled from movement along one of the first set of different directions. When a button moves along one of the first set of different directions and the additional direction simultaneously, the button is actually moving in a third direction represented by a vector having a first component along a direction of the first set of different directions and a second component along the additional direction. In other words, these buttons may be moved only along one of the first set of different directions, only along the additional direction, or simultaneously in both directions (i.e., along the third direction), depending on the force applied to the button by a user.

For example, FIG. 2C shows a cross-sectional side view of one example of an input device 224 that has a button 226 that is able to translate in multiple directions simultaneously. As shown there, the button 226 extends at least partially through a housing 228 along a first direction (as indicated by arrow 230). As shown there, the input device 224 may include a retainer 232 that is positioned and configured to constrain the movement of the button 226. In the variation of input device 224 shown in FIG. 2C, the button 226 may comprise a channel 234 that at least partially circumscribes a portion of the button 226. A channel 234 that fully circumscribes the button 226 may allow for a full 360-degree rotation of the button 226 (e.g., around a rotational axis parallel to the first direction 230, as indicated by curved arrow 236), while a channel 234 that only partially circumscribes the button 226 may restrict the rotational range of the button 226.

The channel 234 may be sized to allow a portion of the retainer 232 (e.g., a lip, protrusion, or the like) to sit within the channel 234, as well as to allow the portion of the retainer 232 to move within the channel 234 in multiple different directions, including along the first direction 230 (which corresponds to the “additional direction” mentioned above) as well as along a set of different directions perpendicular to the first direction 230 (which corresponds to the “first set of different directions” mentioned above, such as indicated by arrows 238). This may in turn allow for the button 226 to be moved along either the first direction 230, one of the first set of directions 238, or simultaneously along both of these directions, depending on the force applied to the button 226. It should be appreciated that the input device 224 may comprise one or more additional components such as springs, spring-biased ball bearings, magnets, or the like (not shown) that may be configured to bias the button 226 to a neutral position, such that button 226 returns to the neutral position when not otherwise acted upon by an external force.

It should be appreciated that the channel 234 may be positioned on any suitable surface of the button 226. For example, in instances where the button 226 comprises a cap and a stem (such as cap 201 and stem 210 discussed above with respect to FIG. 2B), the channel 234 may be defined in either the cap or the stem. Furthermore, while the channel 234 is shown in FIG. 2C as being defined in an outer sidewall of button 226, in other variations a portion of the button 226 (e.g., a cap) may be hollow such that it defines one or more inner sidewalls, and the channel 234 may instead by defined in an inner sidewall of the button. It should also be appreciated that in other variations a channel is instead defined in the retainer 232 and a portion of the button (e.g., a lip or other protrusion) may extend at least partially into the channel. Additionally, while the housing 228 and retainer 232 are shown in FIG. 2C as being two separate components, it should be appreciated that a single component may act as both the housing 228 and retainer 232 (e.g., the housing may act as a retainer).

FIGS. 2D and 2E show another variation of input device 240 comprising a button 242 where movement along any of a first set of different directions 238 is decoupled from the movement along an additional direction 230 perpendicular to the first set of different directions 238. As shown, the input device 240 may comprise a housing 228, a retainer 244, and a channel 246. These components may be configured in any manner as described above with respect to FIG. 2C, except that the channel 246 has multiple regions with different heights, and the portion of the retainer 244 that extends into the channel 246 has a multiple regions with different heights. As shown in FIGS. 2D and 2E, the channel 246 may comprise a first section and a second section that is taller than the first section, and overall has an L-shaped cross-section. Similarly, the portion of the retainer 244 that sits in the channel 246 may comprise a first section and a second section that is taller than the first section, and overall has an L-shaped cross-section.

When the button 242 is translated along one of the first set of different directions 238, a portion of a taller second segment of the retainer 244 may move into a shorter first segment of the channel 246 (as shown in FIG. 2D), which may each be sized such that the taller second segment of the retainer 244 is restricted from traveling along direction 230 when positioned in the shorter segment of the channel 246. In this way, the button 242 may be prevented from being depressed along the additional direction 230 when it has already been moved from a neutral position along one of the first set of different directions 238. Conversely, when the button 242 is in the neutral position, the taller second segment of the retainer 244 may be positioned in the taller second segment of the channel 246, which may allow the button 242 to be pressed along direction 230, such as shown in FIG. 2E. When the button 242 is pressed, the taller second segment of the retainer 244 may no longer be aligned with the shorter first segment of the channel 246, which may prevent lateral translation of the button 242. In this way, the button 242 of input device 240 is configured such that the button 242 may only be moved in one direction at a time (i.e., either along one of the first set of directions 238 or along the additional direction 230).

In other variations where the button extends from (and in some instances extends through) a housing along a first direction, the button may be moveable in a first set of different directions that is coplanar with the first direction. In these variations, the button may be pushed towards the housing in multiple different directions. The button may be further configured to rotate around a rotational axis that is perpendicular to the first set of directions.

For example, FIG. 3 shows a cross-sectional side view of one such input device 300. As shown there, input device 300 may comprise a button 302 that extends at least partially through a housing 304 along a first direction 306. The button 302 may be configured to move in additional different directions (as indicated by arrows 308) that are coplanar with the first direction 306, which may collectively form the first set of different directions as discussed above. In these variations, the input device 300 may be configured to register movement along any of the first set of different directions as a first translational input.

Additionally, the button 302 may further be configured to rotate around a rotational axis that is perpendicular to the first set of different directions 306, 308. For example, the button 302 may comprise an axle or shaft 310 around which (or with which) the button 302 rotates, and the input device 300 may be configured to register this rotation as a rotational input. This may allow the button 302 to act as a dial that can register both translational and rotational inputs. In these variations, as the button 302 rotates, different portions of the button may be protruding outside of the housing 304. The shaft 310 may translate with the rest of the button 302, and dashed line 312 may represent the possible range of travel of the shaft 310 (and with it, the button 302). The input device 300 may be configured to constrict translation of the button to the range of travel 312, and may do so using a track, spring, linkage, or the like. Additionally, in some instances, the input device is configured to bias the button 302 to a neutral position, such as discussed in more detail above.

When a button of an input device is able to move in any of a first set of different directions, it is necessary for the input device to be able to identify that the button has been moved in order to register the movement as a translational input. Additionally, it may be desirable to configure these input devices such that there is a consistent user experience across the various directions a user may move the button to register a translational input. For example, it may be desirable for there to be a consistent stroke (i.e., the distance the button moves between a neutral position and a position at which the translational input is registered) and/or consistent resistance to moving the button regardless of which direction of the first set of different directions the button is moved along.

The following embodiments describe different mechanisms for registering translational inputs from movement of a button along any of multiple different directions. While the following embodiments are described below in the context of variations of the input devices described above with respect to FIGS. 2A-2E and 3, it should be appreciated that these mechanisms may be utilized with any suitable input device in which a button may be moved in a set of different directions.

In some variations, an input device may comprise a button and a switch assembly comprising a rotatable member and at least one switch, wherein the button is moveable along any of a first set of different directions to engage the rotatable member and actuate a corresponding switch of the at least one switch. In these variations, the rotatable member is positioned within the input device such that the rotatable member is configured to rotate and translate relative to a pivot point (which may be fixed relative to a housing of the input device). When the button is moved along one of the first set of different directions, the button applies a force to the rotatable member and causes the rotatable member to move relative to the pivot point. This relative movement actuates the switch (or one of different switches), where the input device registers a first translational input when the switch is actuated.

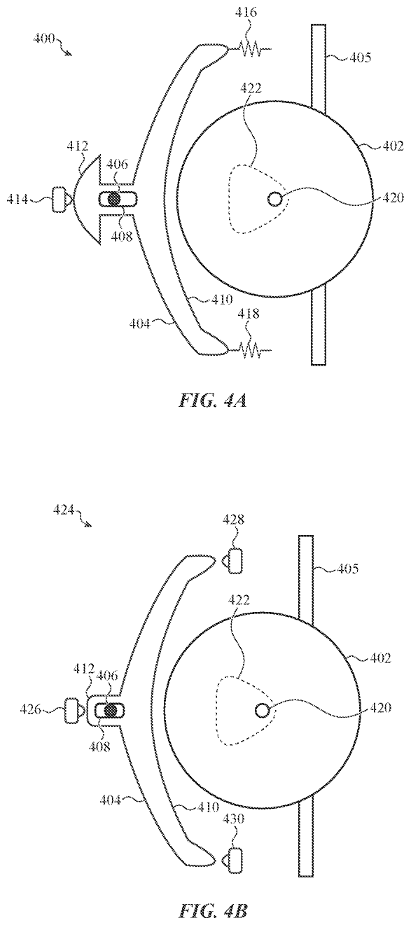

FIG. 4A shows a cross-sectional side view of a variation of an input device 400. As shown there, the input device 400 comprises a button 402, a housing 405, and a switch assembly comprising a rotatable member 404 and a first switch 414. The rotatable member 404 is configured to be rotatable and translatable relative to a pivot point 406. For example, the rotatable member 404 may comprise a track 408 and the pivot point 406 may comprise a shaft that extends at least partially into the track 408. The track 408 may both guide and constrain movement of the rotatable member 404, allowing it to both rotate within the track 408 (i.e., around the pivot point 406) and translate in multiple directions (depending on the orientation of the rotatable member 404) relative to the pivot point 406.

The input device 400 is configured such that movement of the button 402 along any of a first set of different directions (e.g., as indicated by a range of travel 422 and as described above with respect to the input device 300 of FIG. 3) causes the button 402 to engage and move (i.e., rotate and/or translate) the rotatable member 404. While the engagement between the button 402 and the rotatable member 404 may preferably include a portion of the button 402 physically pressing against the rotatable member 404 to move the rotatable member 404, it should be appreciated that the button 402 may apply a movement force to the rotatable member 404 without physically contacting the rotatable member 404. For example, the button 402 and the rotatable member 404 may each comprise one or more magnets, and the button 402 may repulse (or attract) certain portions of the rotatable member 404 as it moves relative to the rotatable member 404.

The resulting movement of the rotatable member 404 may actuate switch 414 to register a translational input. In the variation of input device 400 shown in FIG. 4A, the switch 414 comprises a tactile switch. In these variations, the input device is configured such that a portion of the rotatable member 404 presses a button of the tactile switch to actuate the switch 414. Because the operation of the tactile switch is perceptible to touch, a user may feel the actuation of the tactile switch as the user moves the button 402, thereby allowing the user to know that the translational input has been registered. It should be appreciated that the switch 414 may be any suitable sensor configured to identify that the rotatable member 404 has either come within a predetermined proximity to the switch 414, contacted the switch 414 (e.g., to close an electrical circuit), or contacted and applied a predetermined threshold force to the switch 414. For example, the switch 414 may comprise a force sensor (e.g., a capacitive force sensor, a piezoelectric force sensor, or a piezoresistive force sensor), a proximity sensor (e.g., a magnetic proximity sensor, a capacitive proximity sensor, an optical proximity sensor), or the like. In these variations, the input device 400 (as well as any variations of the input devices described below) may further comprise a haptic output device (not shown), which may generate a vibration in the input device 400 (e.g., via the button 402) when the switch 414 is actuated to provide a user with a perceptible indication that the input device 400 has registered a translational input.

To facilitate actuation of the switch 414, the rotatable member 404 may comprise a proximal contact surface 410 and a distal contact surface 412. The rotatable member 404 may be positioned such that the proximal contact surface 410 faces the button 402 and the distal contact surface 412 faces the switch 414. Movement of the button 402 in any of the first set of different directions causes the button 402 to contact the proximal contact surface 410. Depending on the direction of movement of the button 402, the button 402 may contact different portions of the proximal contact surface 410 (which may result in a different relative amount of translation and rotation of the rotatable member 404).

Similarly, movement of the rotatable member 404 causes the distal contact surface 412 of the rotatable member 404 to move toward (and in some instances contact) the switch 414 to actuate the switch 414. Accordingly, the distal contact surface 412 may actuate the switch 414 when the button 402 is moved in any of the first set of different directions. The profiles of the proximal contact surface 410 and the distal contact surface 412 may together at least partially define the stroke that the button 402 must travel in each of the first set of directions before the rotatable member 404 will actuate the switch 414, and thus the design of these profiles may be adjusted to achieve a particular user feel for moving the button 402 in each these directions. In a preferred embodiment, the proximal contact surface 410 comprises a concave surface, and the distal contact surface 412 comprises a convex surface, though it should be preferred that the contact surfaces may include any suitable combination of profiles (e.g., one or both of the contact surfaces may comprise a concave surface, one or both of the contact surfaces may comprise a convex surface, one or both of the contact surfaces may comprise a surface comprising one or more linear segments, or the like).

In some variations, the input device may comprise one or more springs that are connected to the rotatable member 404. For example, in the variation of input device 400 shown in FIG. 4A, the input device 400 comprises a first spring 416 and a second spring 418, each of which may connect the rotatable member 404 to a stationary component of the input device 400 (which may be any structure that is fixed relative to the housing 405). The one or more springs may serve one or more functions. In some variations, the one or more springs may be configured to bias the rotatable member 404 to a neutral position, and the input device may be configured such that the button 402 is returned to its neutral position when the rotatable member 404 is moved to its neutral position. Accordingly, the springs can bias the button 402 to its neutral position when the button 402 is not otherwise being acted upon by external forces. Additionally or alternatively, the one or more springs may resist rotation and/or translation of the rotatable member 404, which may impact both the stroke of the button 402 and the force that the button 402 needs to apply to the rotatable member 404 in order to actuate the switch 414 as the button 402 moves in one or more of the first set of different directions. Accordingly, the one or more springs and the shape of the rotatable member 404 (e.g., the proximal contact surface 410 and the distal contact surface 412) may each be selected to achieve a desired stroke the button 402 must travel in each of the first set of different directions (as well as the magnitude of force that must be applied to the button in that direction) in order to actuate the switch 414.

The button 402 may also be configured to rotate around a rotational axis that is perpendicular to the first set of different directions, such as discussed in more detail above. As shown in FIG. 4A, the button 402 may comprise an axle or shaft 420 around which (or with which) the button 402 may rotate. In some instances, the button 402 may be further configured to translate along an additional direction that is parallel to the rotational axis (and thus is perpendicular to the first set of different directions, such as described above with respect to the input devices of FIGS. 2A-2E). In these instances, the input device may comprise an additional switch (not shown) configured to actuate in response to movement of the button 402 along the rotational axis, thereby allowing the input device 400 to register a translational input. Because the input device 400 includes two switches (switch 414 and the additional switch), the input device 400 may be able to distinguish between a translational input caused by button movement along one of the first set of different directions and the translational input caused by button movement along the additional direction. In these instances, actuation of the switch 414 is registered as a first translational input and actuation of the additional switch is registered as a second translational input (each of which may be used differently by an electronic device). In other instances, however, the input device 400 does not distinguish between these inputs, and actuation of either the switch 414 or the additional switch is registered as a first translational input.

In other variations, the input device includes a switch assembly comprising a rotatable member and a set of different switches, where the rotatable member is able to actuate each of the set of different switches. For example, FIG. 4B shows one such variation of an input device 424. The input device 424 may share similar components and operate similarly to the variation of input device 400 described above with respect to FIG. 4A, and components sharing the same figure labels may be configured in any suitable manner as described above. As shown in FIG. 4B, the input device 424 may comprise a button 402, a housing 405, and a switch assembly comprising a rotatable member 404 and a set of different switches. The rotatable member 404 is configured to rotate and translate relative to a pivot point 406 (e.g., via a track 408 which may both guide and constrain movement of the rotatable member 404), such as discussed above.

In the variations shown in FIG. 4B, the set of different switches comprises a first switch 426, a second switch 428, and a third switch 430, though it should be appreciated that the set of different switches may include any number of switches as desired. The switch assembly is configured such that each switch is actuated by movement of the button 402 in a corresponding set of one or more directions. For example, as shown in FIG. 4B, the first switch 426 is positioned such that translation of the rotatable member 404 (relative to the pivot point) toward the first switch 426 actuates the first switch 426. The second switch 428 is positioned such that rotation of the rotatable member 404 in a first direction actuates the second switch 428. Similarly, the third switch 430 is positioned such that rotation of the rotatable member 404 in a second direction (opposite the first direction) actuates the third switch 430.

Engagement between the button 402 and the rotatable member 404 (as described above) causes translation and/or rotation of the rotatable member 404 necessary to actuate these switches, and the switch (or switches) that are actuated are dependent on the direction that the button 402 is moved. The button 402 may translate in any of a first set of different directions (e.g., within a range of travel 422) to actuate a respective switch of the set of different switches, which is registered by the input device 424 as a translational input. Each switch of the set of different switches has a corresponding set of one or more directions along which movement of the button will actuate that switch. For example, movement of the button 402 along any direction of a first set of one or more directions actuates the first switch 426 (e.g., translates the rotatable member 404 to actuate the first switch 426). Movement of the button 402 along any direction of a second set of one or more directions actuates the second switch 428 (e.g., rotates the rotatable member 404 in the first direction to actuate the second switch 428). Movement of the button 402 along any direction of a third set of one or more directions actuates the second switch 428 (e.g., rotates the rotatable member 404 in the first direction to actuate the second switch 428). Collectively, the first, second, and third sets of one or more directions make up the first set of directions such that at least one switch is actuated by movement of the button 402 in each of the first set of directions.

In some instances, there is no overlap between the corresponding sets of one or more directions for the set of different switches (e.g., no overlap between the first, second, and third sets of one or more directions mentioned above), such that movement along any direction of the first set of different directions actuates a single switch. Alternatively, there may be overlap between two sets of the corresponding sets of one or more directions (e.g., an overlap between the first set and the second set and/or between the first set and the third set of one or more directions mentioned above), such that movement along one or more directions of the first set of different directions actuates multiple switches.

Because different switches (or groups of switches) may be actuated depending on the direction of movement of the button 402, the input device 424 may be configured to distinguish between actuation of different switches (or groups of switches) when registering a translational input. For example, in the embodiment of FIG. 4B, the input device 424 may be configured to register any of a first translational input when the first switch is actuated, register a second translational input when the second switch is actuated, and register a third translational input when the third switch is actuated. In this way, the input device 424 (or an electronic device using the input device 424) may use the first, second, and third translational inputs differently (e.g., as different inputs to have different impacts on device operation).

Alternatively, the input device 424 may not distinguish between actuation of the individual switches of the set of different switches, and the input device is configured such that actuation of any of the set of different switches is registered as the same first input. In this way, the input device 424 (or an electronic device using the input device 424) may operate the same regardless of which switch (or switches) of the set of different switches is actuated.

When an input device has a switch assembly comprising a set of different switches, it should be appreciated that the switches may be any combination of suitable switches, such as those described above. For example, the switches may all be of the same type (e.g., first switch 426, second switch 428, and third switch 430 are shown in FIG. 4B as being tactile switches), while in other variations some switches may be of different types (e.g., a first set of one or more switches may comprise tactile switches while a second set of one or more switches may comprise proximity sensors).

While not shown in FIG. 4B, the input device 424 may comprise one or more springs, which may operate in any manner such as described above with respect to input device 400 of FIG. 4A. Similarly, the shape of the rotatable member 404 (as well as the design and placement of any springs connected to the rotatable member 404) may impact the stroke and force requirements of the button 402 required to register a translational input, as discussed in more detail above.

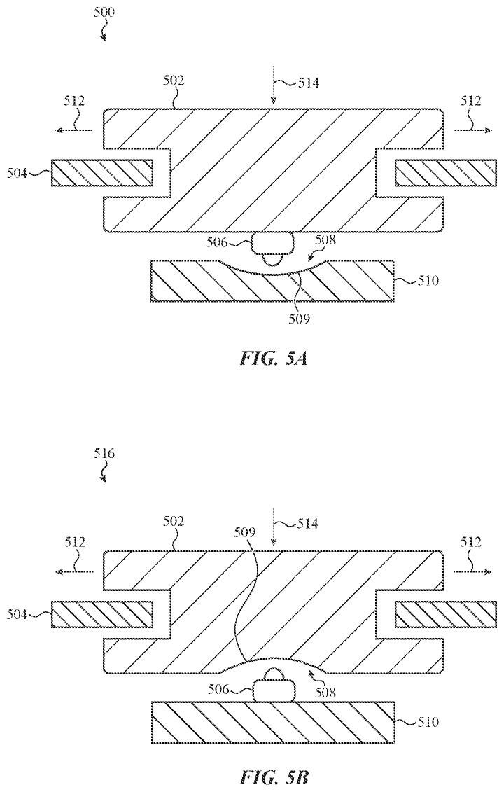

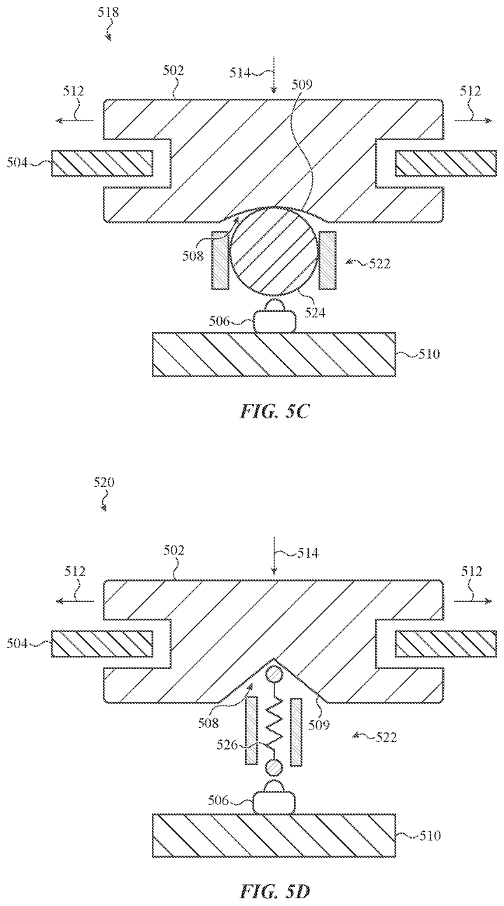

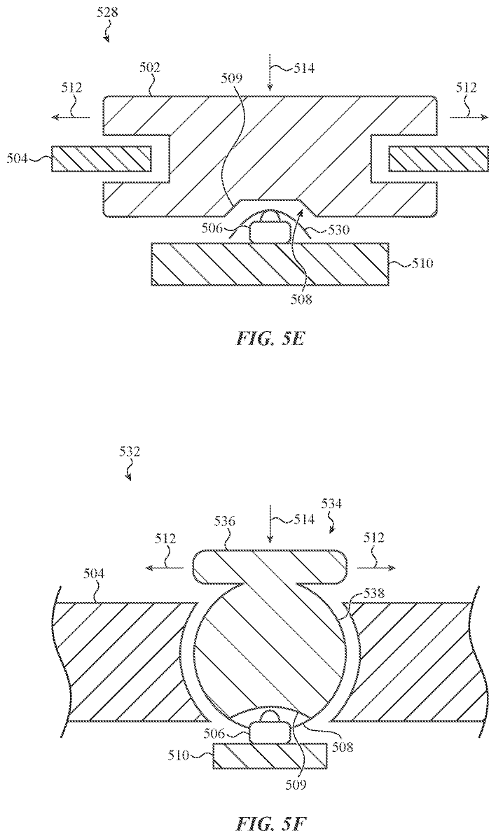

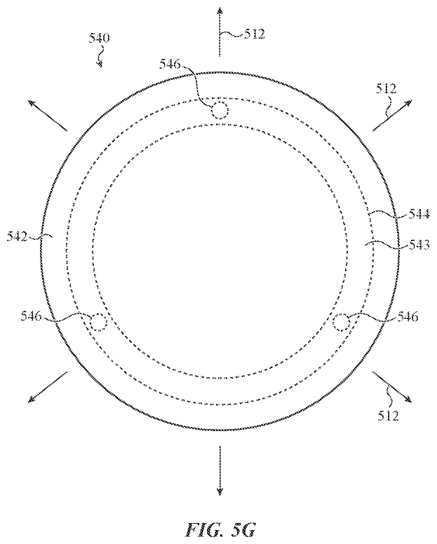

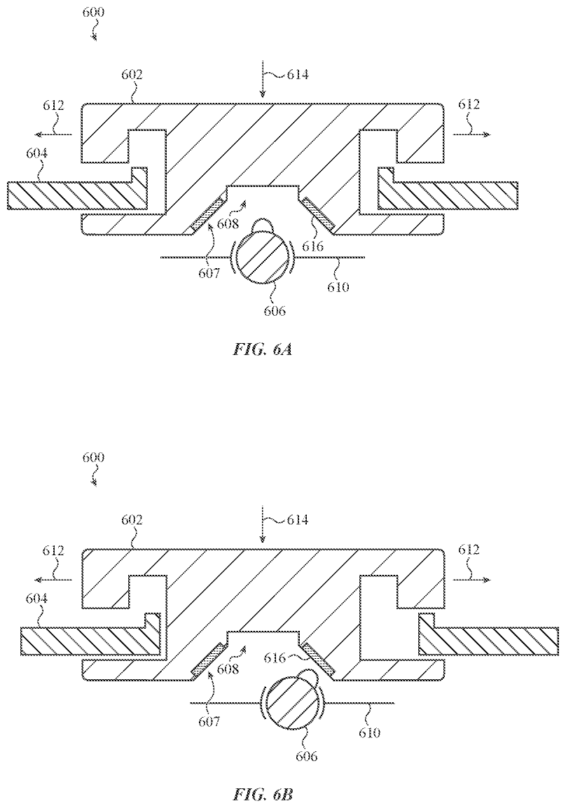

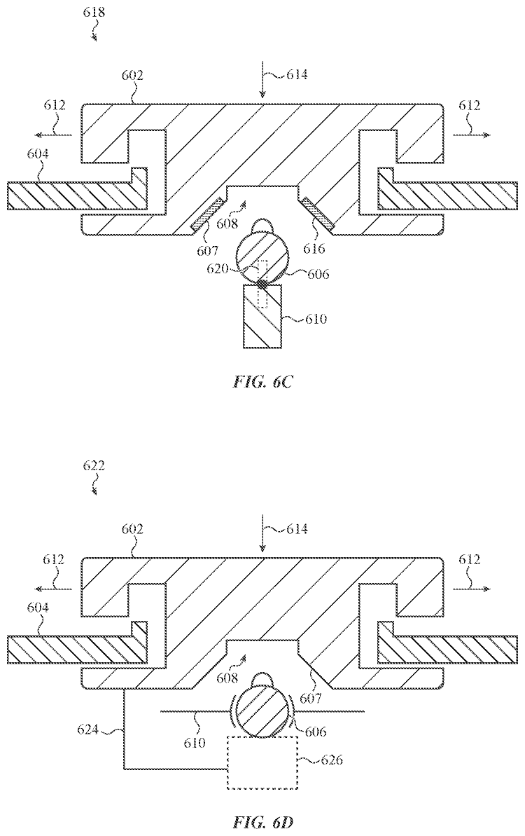

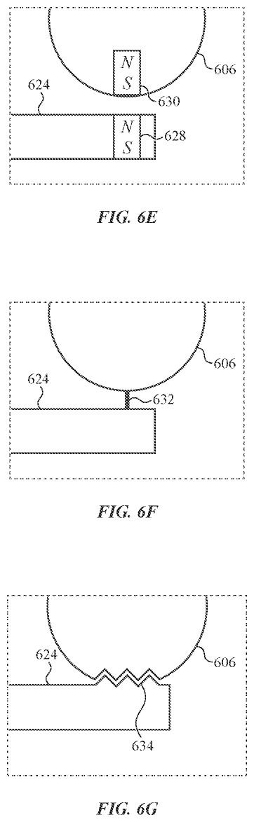

In some variations of the input devices described here, the input device includes a switch assembly that comprises a switch and a surface defining a cavity, wherein relative movement between the switch and the cavity in any of a first set of different directions actuates the switch to register a translational input. The portion of a surface of a given component that defines a cavity is referred to herein as a “cavity surface”, which are separate from other portions of the component's surface that do not contribute to defining the bounds of the cavity). These input devices are configured such that movement of a button along any of a first set of different directions results in relative movement between the cavity surface and the switch to actuate the switch (and thus register the translational input). FIGS. 5A-5G and 6A-6G show multiple variations of input devices that comprise switch assemblies with cavity surfaces that define cavities.

Specifically, FIG. 5A shows a variation of an input device 500 comprising a button 502, a housing 504, and a switch assembly that comprises a switch 506, a cavity surface 509 defining a cavity 508, and a stationary component 510. The button 502 is moveable along a first set of different directions (as indicated by arrows 512) to actuate the switch 506. In some instances, such as shown in FIG. 5A, the first set of different directions is oriented such that movement in these directions moves the button 502 laterally relative to the housing 504 to actuate the switch 506 and register a translational input (such as in the variations of input devices 206, 224, and 240 described above with respect to FIGS. 2B, 2C, and 2D), though in other variations the first set of different directions is oriented to allow the button to be pressed further inside the housing along these directions to actuate the switch 506 and register a translational input (such as in the variation of input device 300 described above with respect to FIG. 3). Additionally, in some instances, the input device 500 may be further configured such that the button 502 is configured to rotate around a rotational axis and/or move along an additional direction perpendicular to the first set of different directions, such as described in more detail above.

Stationary component 510 may be any physical structure that is held or otherwise placed in a fixed position relative to the housing 504 (and in some instances, may even be a portion of the housing 504). In the variation shown in FIG. 5A, the cavity surface 509 that defines the cavity 508 is part of the stationary component 510 (i.e., the cavity 508 is defined in the stationary component 510), and the switch 506 is fixedly connected to and moveable with the button 502. In these variations, movement of the button 502 along any of the first set of different directions moves the switch 506 relative to the cavity surface 509 and cavity 508 to actuate the switch 506. Depending on the selection and design of the switch 506 (which may be any switch as described above), actuation of the switch 506 may result when either a portion of the cavity surface 509 comes within a predetermined proximity to the switch 506, contacts the switch 506 (e.g., to close an electrical circuit), or contacts and applies a predetermined threshold force to the switch 506. For example, in the variation shown in FIG. 5A, the switch 506 comprises a tactile switch, and actuation of the switch 506 occurs when contact between the cavity surface 509 and the tactile switch presses a button of the tactile switch.

Additionally, in input devices where the button is also moveable along an additional direction perpendicular (e.g., along direction 514) to the first set of different directions, this movement also causes relative movement between the switch 506 and the cavity surface 509 to actuate the switch 506 and register a translational input. Alternatively, these input devices may comprise an additional switch, such that movement along the additional direction actuates the additional switch instead of the switch 506.

The size and profile of the cavity surface 509 (which in turn defines the size and shape of cavity 508), as well as the relative positioning between the switch 506 and the cavity surface 509, may define the stroke of how much the button 502 may need to move in each of the first set of different directions in order to actuate the switch 506 and register a translational input. Additionally, in instances where the button 502 may move in an additional direction perpendicular to the first set of different directions to actuate the switch 506 (either simultaneously or separately), these parameters may further define how much the button 502 needs to move along the additional direction in order to register a translational input. This may allow the input device 500 to be designed to have a desired user experience in pressing the button 502 along these directions to provide an input.

While the cavity 508 is shown in FIG. 5A as defined in the stationary component 510, it should be appreciated that in other instances the cavity surface 509 is part of the button 502 such that the cavity 508 is defined in a portion of the button 502. For example, FIG. 5B shows one such variation of input device 516. Input device 516 is the same as input device 500 (and utilizes the same figure labels), except that the button comprises the cavity surface 509 and the cavity 508 is defined in the button 502 (and thus is moveable with the button 502) and the switch 506 is fixedly connected to the stationary component 510. In these variations, movement of the button 502 in any of the first set of different directions 512 (and optionally along the additional direction 514 perpendicular to the first set of different directions 512) causes the cavity surface 509 and cavity 508 to move relative to the switch 506 and the stationary component 510 to actuate the switch 506.

In some variations, switch assemblies described herein that comprise a cavity surface and a switch may further comprise an intermediate component positioned between the cavity surface and the switch. These switch assemblies may be configured such that relative movement between the cavity surface and the switch causes movement of the intermediate component relative to the switch. In these variations, the relative movement between the intermediate component and the switch actuates the switch. Thus, relative movement between the switch and the cavity surface in any of a first set of different directions actuates the switch to register a translational input via movement of the intermediate component. Preferably, the intermediate component is constrained to move in a single direction and the switch assembly is configured such that that movement of the button in any of a first set of different directions results in movement of the intermediate component in the single direction.

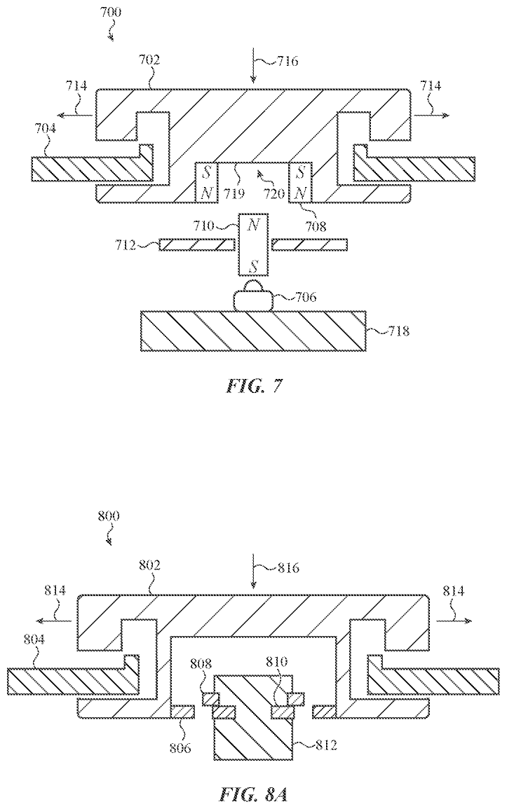

FIGS. 5C and 5D show two variations of input devices (input device 518 and input device 520 respectively) having switch assemblies comprising an intermediate component 522 positioned between a switch 506 and a cavity surface 509 that defines cavity 508. Input device 518 and input device 520 may otherwise be configured as described above with respect to FIG. 5B, and common components are labeled the same. As shown there, the cavity 508 is defined in the button 502 and a portion of the intermediate component 522 extends into the cavity 508 to contact the cavity surface 509 (though it should be appreciated that an intermediate component need not contact the cavity surface 509 in order for movement of the cavity surface 509 to cause movement of the intermediate component 522, as will be described below with respect to FIG. 7). The intermediate component 522 may be biased toward the cavity surface 509 (e.g., by one or more springs or the like), which may cause the intermediate component 522 to remain in contact with the cavity surface 509 as the button 502 and the cavity surface 509 move relative to the intermediate component 522.

The portion of the cavity surface 509 contacted by the intermediate component 522 changes as the cavity surface 509 moves relative to the intermediate component 522 along any of the first set of different directions 512, and the intermediate component 522 is effectively pushed away from the button 502 as it contacts the shallower portions of the cavity 508. Specifically, in some variations, the switch assembly may be configured such that the intermediate component 522 extends a first distance into the cavity 508 (which may optionally be the farthest distance the intermediate component 522 is capable of extending into the cavity 508) when the button 502 is in a neutral position. The profile of the cavity surface 509 is configured such if the button 502 is moved in any direction of the first set of different directions, there is at least one point along that direction where the intermediate component 522 extends a second distance into the cavity 508, wherein the second distance is less than the first distance by an amount sufficient to cause intermediate component 522 to actuate switch 506. In this way, the switch 506 may be actuated to register a translational input from movement of the button 502 along any of the first set of directions.

As mentioned above, the intermediate component 522 may be configured such that it may only move along a single direction. For example, the intermediate component 522 may be slidably positioned within a channel defined through a stationary component (which may be separate from or an extension of the stationary component 510) or a sleeve. In instances where the button 502 is moveable in an additional direction 514 perpendicular to the first set of different directions 512, the single direction may preferably be parallel to this additional direction 514. Alternatively, the single direction may be another direction that is not coplanar with the first set of different directions. In these variations, movement of the button 502 in any of the first set of different directions may result in movement of the intermediate component 522 along the single direction. Additionally, in variations where the button 502 is also configured to move along the additional direction 514, movement of the button 502 along the additional direction 514 may also result in movement of the intermediate component 522 along the single direction.

Movement of the intermediate component 522 along the single direction may actuate the switch 506 in any suitable manner as described above. For example, in some variations, the switch 506 may be actuated when the intermediate component 522 comes within a predetermined proximity of the switch 506. In other variations, the switch 506 may be actuated when the intermediate component 522 contacts the switch 506 (e.g., to close an electrical circuit). In still other variations, the switch 506 may be actuated when the intermediate component 522 contacts and applies a predetermined threshold force to the switch 506.

The intermediate component 522 may comprise a spring or a structure with any shape suitable to engage both the cavity surface 509 and the switch as described above. For example, the intermediate component 522 may comprise a sphere, ovoid, box, capsule or the like. As a couple of non-limiting examples, the input device 518 of FIG. 5C is shown there as having an intermediate component 522 comprising a sphere 524, while the input device 520 of FIG. 5D is shown there as having an intermediate component 522 comprising a spring 526, though it should be appreciated that any other intermediate component may be substituted for those shown there. In some variations where the intermediate component 522 comprises a spring 526, the spring 526 may be configured to maintain contact with both the cavity surface 509 and the switch 506. In these variations, motion of the cavity surface 509 relative to the spring 526 may compress the spring 526 against the switch 506, and the switch 506 is actuated when the spring 526 is compressed enough to apply a predetermined threshold force to the switch 506. For the purpose of this application, compression of the spring 526 along a direction is considered movement of the spring along that direction.

The size and shape of the intermediate component 522 (as well as the spring constant in instances where the intermediate component 522 comprises a spring) may at least partially determine how much the intermediate component 522 moves (and/or the amount of force it applies to the switch 506) as a result of movement of the button 502. Similarly, the profile of the cavity surface 509 also at least partially determines how much the intermediate component 522 moves as a result of movement of the button 502. The cavity surface 509 is configured such that cavity 508 may have any suitable cross-sectional shape. For example, the cavity 508 may have a curved cross-section (such as shown in FIGS. 5A-5C and 5F), a triangular cross-section (such as shown in FIG. 5D), a trapezoidal cross-section (such as shown in FIG. 5E), or the like. The cavity surface 509 and cavity 508 are preferably rotationally symmetric but need not be.

In some instances it may be desirable for a switch of the input devices described herein to have a particular size and shape for engaging with a cavity surface or an intermediate component. Accordingly, the input devices described herein may comprise a shell that is connected to the switch. The shell determines an exterior portion of the switch and may engage a cavity surface or intermediate component to actuate the switch. For example, FIG. 5E shows one such variation of an input device 528 comprising a switch 506 and a shell 530 attached to the switch 506. The input device 528 may otherwise be configured in any manner described above with respect to FIGS. 5A-5D (and common components are labeled the same). In instances where actuation of the switch 506 is based on identifying contact with and/or application of a threshold force to the switch 506, contact with and/or force applied to the shell 530 (e.g., via the cavity surface 509 or an intermediate component) may be detected by the switch 506 to actuate the switch. The shell 530 may be optionally electrically conductive, which in some instances may be used to close an electrical circuit to detect contact with the shell 530.

In another example, the switch 506 may be a tactile switch and the shell 530 may be attached to a button of the tactile switch. In such a variation, relative movement between the cavity surface 509 and the switch 506 (e.g., as the button 502 is moved in one of the first set of different directions) causes the cavity surface 509 to press against the shell 530, which in turn may depress the button of the tactile switch to register a translation input. The use of a shell 530 may provide flexibility in selecting components for a given input device (or range of input devices). For example, the same switch 506 may be incorporated into two different input devices, and shells of different shapes may be attached to effectively provide switches having two different shapes (and thus may provide two different user experiences when registering a translational input).

While the embodiments of input devices described above with respect to FIGS. 5A-5E all depict switch assemblies where the relative movement between the surface 509 and the switch is translational, it should be appreciated that in other variations this relative movement may also include a rotational component. For example, FIG. 5F shows one such variation of an input device 532 comprising a button 534, a housing 504, and a switch assembly comprising a switch 506 and a cavity surface 509 defining a cavity 508. As shown there, the button 534 comprises a cap 536 and a pivot portion 538 and is positioned relative the housing 504 such that the button can pivot around the pivot portion 538 in multiple rotation directions to move the cap 536 in a first set of different directions 512 (in these variations, the cap 536 may also rotate when moving in each of the first set of different directions). The button may also be rotated around a rotation direction perpendicular to the first set of different directions 512 (e.g., rotating around direction 514) to register a rotational input. In the variation shown in FIG. 5F, the button 534 (e.g., in the pivot portion 538 of the button) includes the cavity surface 509 and cavity 508 is defined in the button 534, such that as the button 534 pivots to move the cap 536 in one of the first set of different directions, the cavity surface 509 and cavity 508 rotates and translates relative to the switch 506. This relative motion may cause the cavity surface 509 (or an intermediate component between the cavity surface 509 and the switch 506, as described above) to engage and actuate the switch 506. While the cavity 508 is shown in FIG. 5F as defined in the button 534 and the switch 506 is shown there as being connected to a stationary component 510, the switch assembly may alternatively be configured such that the switch 506 may be fixedly connected to and moveable with the button 534 (e.g., fixedly connected to and moveable with the pivot portion 538) and the stationary component 510 includes the cavity surface 509 (and cavity 508 is defined in the stationary component 510).

When the buttons described above with respect to FIGS. 5A-5F are configured to rotate around a rotational axis perpendicular to the first set of different directions, it may be preferable to position the switch and cavity surface centered on the rotational axis when the button is in a neutral position. This may allow the switch and cavity surface to engage each other to actuate the switch, regardless of how much the button is rotated around the rotational axis. Conversely, if the switch and cavity surface are positioned too far from the rotational axis, rotation of the button may move the cavity away from the switch (or vice versa), such that motion of the button along some or all of the first set of different directions will not result in actuation of the switch.

To address this, in some instances, an input device may include a switch assembly having a cavity surface that defines a cavity and a first set of switches, where both the cavity surface and the first set of switches are positioned so they do not intersect a rotational axis of the button. FIG. 5G shows a top view of one such variation of an input device 540 comprising a button 542 and a switch assembly comprising an annular cavity surface 543 defining an annular cavity 544, a first set of switches 546, and a stationary component (not shown). The annular cavity 544 may be defined in either the button 542 or a stationary component, and the first set of switches may be fixedly connected to the other of the button 542 and the stationary component.

Each of the set of different switches is positioned such it is aligned with the annular cavity surface 543 and annular cavity 544 when the switch is in the neutral position. The annular cavity surface 543 and annular cavity 544 in turn may be centered around a rotational axis (not shown) of the button 542. When the button 542 moves along one of the first set of directions (shown in FIG. 5G as arrows 512, which are perpendicular to the rotational axis), the annular cavity surface 543 may translate relative to each of the set of multiple of switches 546, which may actuate one or more of the set of different switches such as described above. At the same time, rotation of the button 542 around the rotational axis will cause relative rotation between the annular cavity 544 and the set of different switches 546, but each of the set of different switches will remain aligned with the annular cavity surface 543 and annular cavity 544 during this relative rotation. While it may be possible for the set of different switches 546 to be replaced by a single switch, the annular nature of the annular cavity surface 543 may require the button to travel farther in some of the first set of different directions than in others to be able to actuate the switch. Conversely, having a set of different switches (e.g., two, three, or four or more switches) may increase the uniformity of required stroke across the first set of different directions to register a translational input.

In some variations of the input devices described here, the input device may comprise a button and a switch, where the switch is coupled to a stationary component and is configured to change orientation when the button moves in any of a first set of different directions. For example, FIGS. 6A and 6B show cross-sectional side views of one such variation of an input device 600. As shown there, the input device 600 may comprise a button 602, a housing 604, and a switch assembly comprising a switch 606 and a cavity surface 607 defining a cavity 608. The button 602 is configured to move in a first set of different directions 612 (such as described above with respect to FIGS. 2A-2E and 3) and may optionally be further configured to move in an additional direction 614 perpendicular to the first set of different directions 612 and/or rotate around a rotational axis parallel to the additional direction 614.

The switch 606 is pivotable in multiple pivot directions and is configured to pivot in response to relative movement between the switch 606 and the cavity surface 607 (and thus between the switch 606 and cavity 608). The switch assembly is configured such that movement of the button 602 along any of the first set of different directions 612 results in relative movement between the cavity surface 607 and switch 606 to actuate the switch 606 (and thus register the translational input), such as described in more detail above. When the switch 606 is able to pivot during relative movement between the switch 606 and the cavity surface 607, the relative orientation of the switch 606 and the cavity surface 607 changes during this motion. This may be used to align a portion of the switch 606 with a portion of the cavity surface 607, which may facilitate actuation of the switch 606.

For example, in the variation of input device 600 shown in FIGS. 6A and 6B, the switch 606 may comprise a tactile switch. When the button is in a neutral position as shown in FIG. 6A, the button of the tactile switch may be aligned with a direction 614 perpendicular to the first set of directions 612. In variations where the button 602 is moveable along this direction 614 (e.g., the “additional direction” described above), the button 602 may be moved along direction 614 to actuate the switch 606 as a first portion of the surface of the cavity 608 presses the button of the tactile switch. The profile of the cavity surface 607 may be configured such that the switch (which is aligned with direction 614) is positioned normal to the first contact point of the surface of the cavity surface 607 (i.e., the button faces the first contact point) as it contacts the cavity surface 607.

When the button 602 is moved along one of the first set of different directions 612, the switch 606 may contact a second contact point of the surface of the cavity surface 607. If the switch 606 were to maintain its orientation, during this motion, the switch 606 would not be positioned normal to the second contact point as the button of the tactile switch is pressed. This may result in a different user feel when actuating the switch 606 by moving the button along the additional direction 614 as compared to doing the same moving the button 602 along one of the first set of different directions 612. In the present variation, however, the switch 606 pivots as the button 602 moves along any of the first set of directions 612, resulting in the switch 606 being aligned normal (or another predetermined angle) to the second contact point, such as shown in FIG. 6B. In this way, the input device may be configured such that the switch has the same relative orientation to whatever portion of the surface 608 the switch 606 contacts, regardless of which direction from the first set of different directions 612 and the additional direction 614 along which the button 602 is moved. This in turn may provide for a more consistent user experience in providing a translational input via the button 602.

The input device 600 may comprise any number of mechanisms for pivoting the switch 606 in response to movement of the button 602. For example, in the variation of input device 600 shown in FIGS. 6A and 6B, the cavity 608 is defined in the button 602 (i.e., the button 602 includes the cavity surface 607), and the switch 606 is pivotably coupled to a stationary component 610. Specifically, the stationary component 610 (which may be any physical structure that is held or otherwise placed in a fixed position relative to the housing 604 as discussed above) may define a cavity or comprise a holding structure that allows the switch 606 to pivot in multiple pivot directions but is restricted from translating relative to the stationary component 610. In other words, a pivot point of the switch 606 is fixed in one spot, but the switch 606 may change its orientation by rotating around its pivot point. While the cavity 608 is shown in FIGS. 6A and 6B as being defined in the button 602 (i.e., the cavity surface 607 is part of the button 602), in other variations the cavity 608 is defined in the stationary component 610 (i.e., the cavity surface 607 is part of the stationary component 610), and the switch 606 is pivotably coupled to the button 602.

In some variations, one or more magnets may be configured to pivotally connect the switch 606 to the stationary component 610 or the button 602. For example, FIG. 6C shows a variation of input device 618, which is shown and labeled the same as FIGS. 6A and 6B except that the switch 606 is pivotably coupled to the stationary component 610 by a magnet assembly 620. In these variations, the switch 606 is magnetized (e.g., comprises a first magnetic component) and the stationary component 610 is magnetized (e.g., comprises a second magnetic component) such that the switch 606 is magnetically attracted to the stationary component 610. This attraction may hold the switch 606 against the stationary component 610 while still allowing the switch 606 to pivot relative to the stationary component.

The switch assembly may further comprise one or more components configured to pivot the switch 606 as the button 602 is moved in any of the first set of different directions. For example, in the variations of input devices 600 and 618 described above with respect to FIGS. 6A-6C, the switch 606 is magnetically attracted to at least a portion of the cavity surface 607, which causes the switch 606 to pivot toward the cavity surface 607 as these portions of the cavity surface 607 get closer to the switch. For example, the component that has the cavity surface 607 may comprise one or more magnets 616 (e.g., a ring-shaped magnet or multiple individual magnets) and the switch 606 may comprise one or more magnets (not shown). As the cavity surface 607 is moved relative to the switch 606, a portion of the cavity surface 607 may move closer to the switch and the magnetic force between the one or more magnets of the switch 606 and a portion of the one or more magnets of the cavity surface 607 increases to cause the switch to pivot toward that portion of the cavity 608.

In other variations, another portion of a button 602 may facilitate pivoting of the switch 606. For example, FIG. 6D shows a variation of an input device 622 which is configured and labeled the same as the input device 600 except that instead of the cavity surface 607 comprising one or more magnets 616, the button 602 comprises an extension 624, which is a portion of the button that engages and pivots the switch 606 at an interface (depicted in FIG. 6D as box 626) between the extension 624 and the switch 606. In some variations, such as shown in FIG. 6E, the interface 626 may comprise a magnet arrangement (e.g., the extension 624 may comprise a first magnet 628 and the switch 606 may comprise a second magnet 630) configured to provide an attractive force between the extension 624 and the switch 606. Movement of the button 602 (and with it the extension 624 and first magnet 628) changes the direction of the attractive force between the extension 624 and the switch 606, causing the switch 606 to pivot.

In other variations, there may be a mechanical connection between the extension 624 and the switch 606. For example, such as shown in FIG. 6F, the interface 626 may comprise a tether 632 connecting the extension 624 to the switch 606. In these embodiments, movement of the button 602 may cause the extension 624 to pull the switch 606 into a new orientation. In variations where the button 602 is moveable along an additional direction 614, the tether 632 may have sufficient elasticity or the extension 624 may be otherwise configured to accommodate this movement. In other variations, such as shown in FIG. 6G, the interface 626 may comprise a gear interface 634. In these variations, the extension 624 may comprise a first pattern of teeth and the switch 606 may comprise a corresponding pattern of teeth to make an omnidirectional driving gear, such that movement of the extension 624 in any of the first set of different directions causes a corresponding rotation of the switch 606.

In other variations of the input devices described here, the input devices may include a button and a switch assembly comprising a first magnet arrangement, a switch, and a magnetic intermediate component positioned between the first magnet arrangement and the switch. For example, FIG. 7 shows a cross-sectional side view of one such variation of an input device 700. As shown there, input device 700 comprises a button 702, a housing 704, and a switch assembly comprising a switch 706, a first magnet arrangement 708, and a magnetic intermediate component 710 positioned between the switch 706 and the first magnetic arrangement 708. The first magnet arrangement 708 may include a ring-shaped magnet, multiple individual magnetics in a concentric arrangement, or the like. The button 702 is configured to move in a first set of different directions 714 (such as described above with respect to FIGS. 2A-2E and 3) to register a translational input. The button 702 may optionally be further configured to move in an additional direction 716 perpendicular to the first set of different directions 714 (e.g., to register a translational input) and/or rotate around a rotational axis parallel to the additional direction 716 (e.g., to register a rotational input).

The switch assembly is configured such that movement of the button 702 along any of a first set of different directions 714 causes the first magnet arrangement 708 to push the magnetic intermediate component 710 toward the switch 706 to actuate the switch (in any manner as discussed above) to register a translational input. For example, the magnetic fields of the first magnet arrangement 708 and the magnetic intermediate component 710 may be arranged to create a repulsive force between the first magnet arrangement 708 and the intermediate component 710. Movement of the button 702 along one of the first set of directions 714 causes relative movement between the first magnet arrangement 708 and the magnetic intermediate component 710. Specifically, as the button 702 is moved away from a neutral position, the magnetic intermediate component 710 may be moved closer to a portion of the first magnet arrangement 708, thereby increasing the repulsive force between the two. As the repulsive force increases, the magnetic intermediate component 710 is biased toward the switch 706 and may actuate the switch 706 to register a translational input. In some variations, the magnetic intermediate component 710 may be slidably positioned within a channel defined through a holding component 712, which may constrain movement of the magnetic intermediate component 710 to a single direction.

To create the relative movement between the first magnet arrangement 708 and the magnetic intermediate component 710, the first magnet arrangement 708 may be fixedly connected to the button 702 such that the first magnet arrangement 708 is moveable with the button 702. In these variations, the magnetic intermediate component 710, holding component 712, and the switch 706 may be connected to a stationary component 718, such as described above. In these variations, movement of the button 702 moves the first magnet arrangement 708 relative to the magnetic intermediate component 710.

Alternatively, the magnetic intermediate component 710, holding component 712, and switch 706 may be fixedly connected to the button 702 such that the magnetic intermediate component 710, holding component 712, and switch 706 are moveable with the button 702. In these variations, the first magnet arrangement 708 may be connected to the stationary component 718 (which may be any physical structure that is held or otherwise placed in a fixed position relative to the housing 704 as discussed above). In these variations, movement of the button 702 moves the magnetic intermediate component 710 relative to the first magnet arrangement 708.

The switch assembly of input device 700 may comprise a cavity surface 719 defining a cavity 720 (such as shown in FIG. 7) but need not. In variations, the input device 700 comprises a cavity surface 719 defining a cavity 720, a portion of the magnetic intermediate component 710 may extend at least partially into the cavity (e.g., as the button 702 is moved along direction 716). The first magnet arrangement 708 may be positioned around (in some instances may at least partially define) the cavity 720 (i.e., at or near the cavity surface 719). It may be possible to register a translational input when the button is moved in any of the first set of different directions 714 as well as the additional direction 716 without the magnetic intermediate component 710 physically contacting the cavity surface 719. In other variations, the magnetic intermediate component 710 may contact a portion of the cavity surface 719 when the button is moved along the additional direction 716, which may allow the cavity surface 719 to press the intermediate component 710 and facilitate actuation of the switch 706.

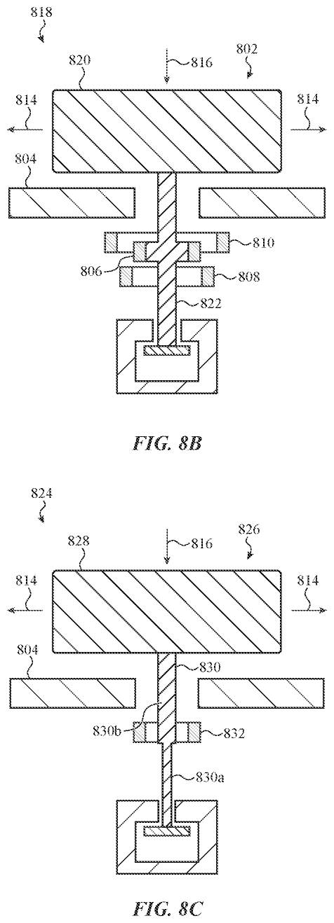

As mentioned above, when the input devices described above utilize a tactile switch, actuation of the tactile switch may provide perceptible feedback to a user, while the use of other switches may not. Accordingly, it may be desirable to configure an input device to provide a varying resistance to movement of a button along any of a first set of directions, which may replicate the feel of depressing the button of a tactile switch (or another desirable force profile). In some instances, the input devices may comprise one or more magnets configured to adjust the resistance to moving the button along any of the first set of directions. FIGS. 8A-8C show three such variations of input devices.

For example, FIG. 8A shows a first variation of an input device 800 comprising a button 802, a housing 804, and a magnet assembly comprising a first magnet 806, a second magnet 808, and a third magnet 810. The button 802 is configured to move in a first set of different directions 814 (such as described above with respect to FIGS. 2A-2E and 3) and may optionally be further configured to move in an additional direction 816 perpendicular to the first set of different directions 814 and/or rotate around a rotational axis parallel to the additional direction 816. Each of the first magnet 806, second magnet 808, and third magnet 810 is preferably configured as a ring magnet, although any or all of these magnets may be configured as multiple individual magnets fixed in a concentric arrangement.

The magnet assembly is configured such that the first magnet 806 is moved relative to the second magnet 808 and the third magnet 810. For example, as shown in FIG. 8A, the first magnet 806 is fixedly connected to the button 802 such that the first magnet 806 is moveable with the button 802 along the first set of directions. The second magnet 808 and the third magnet 810 are connected to a stationary component 812 (which may be any physical structure that is held or otherwise placed in a fixed position relative to the housing 804 as discussed above). The first magnet 806 may have a first diameter which is larger than a second diameter of the second magnet 808, which is in turn larger than a third diameter of the third magnet 810. Additionally, the magnetic fields of the first, second, and third magnets may be configured such that the first magnet 806 is repulsed by the second magnet 808 and is attracted to the third magnet 810.

When the button 802 is in a neutral position such as shown in FIG. 8A, the first magnet 806 is closer to the second magnet 808 than the third magnet 810. As the button 802 is moved along one of the first set of directions 814, a portion of the first magnet is moved toward a corresponding portion of the second magnet 808 and the third magnet 810. The repulsive force between the first magnet 806 and the second magnet 808 will resist this movement, while the attractive force between the first magnet 806 and the third magnet 810 facilitates the movement. The magnet assembly may be configured such that initially the repulsive force increases at a faster rate than the attractive force increases, such that over a first portion of the stroke the overall resistance to movement increases. The magnet assembly may be further configured that, at a certain point, the attractive force starts to increase faster than the repulsive force increases, such that over a second portion of the stroke the overall resistance to movement decreases.

Eventually the first magnet 806 will contact a stationary portion of the input device 800 (e.g., the second magnet 808, the third magnet 810, or the stationary component 812), which will resist further movement of the first magnet 806 (and with it, the button 802). Accordingly, when a user moves the button 802 along one of the first set of different directions 814, the force required to move the button will increase, then decrease, then increase again. The exact transition points may be tailored to achieve a desired feedback to the user. The input device 800 may be configured to register a translational input at a desired point along the stroke of the button 802, preferably when the first magnet 806 contacts the stationary portion of the input device 800. This contact may be detected using any suitable switch or switch assembly such as described in more detail above. When the button 802 is no longer being pressed by a user, the magnet assembly may be configured such that the second magnet 808 biases the button 802 back to the neutral position.

While the first magnet 806 is shown in FIG. 8A as having a larger diameter than the diameters of the second magnet 808 and the third magnet 810, in other variations the diameter of first magnet 806 may be smaller than the second and third magnets. For example, FIG. 8B shows one such variation of input device 818. As shown there, the input device 818 comprises a button 802, a housing 804, and a magnet assembly comprising a first magnet 806, a second magnet 808, and a third magnet 810. As shown there, the button 802 may comprise a cap 820 and a stem 822, though it should be appreciated that the magnet assembly may be used with any input device such as described above with respect to FIGS. 2A-2E and 3.

In this variation, the first magnet 806 may have a first diameter that is less than a second diameter of the second magnet 808, and the second diameter of the second magnet 808 is less than a third diameter of the third magnet 810. The first magnet 806 is fixedly attached to the button 802 (e.g., to the stem 822), and the second magnet 808 and the third magnet 810 are connected to a stationary component (not shown). The magnetic fields may otherwise be configured as described above with respect to FIG. 8A, such that magnet assembly variably resists movement as the button is moved in any of the first set of directions.

FIG. 8C shows a cross-sectional side view of a third variation of an input device 824 comprising a magnet assembly. As shown there, the input device 824 may comprise a button 826 with a cap 828 and a stem 830, a housing 804, and a magnet assembly comprising a first magnet 832 and a second magnet. The button 826 may be moveable along a first set of different directions 814 and optionally moveable along (and/or rotatable around) an additional direction 816 perpendicular to the first set of different directions 814 as discussed above. The first magnet 832 may be a ring magnet or multiple individual magnets fixed in a concentric arrangement and may be connected to a stationary component (not shown) of the input device 824. The second magnet may be connected to the stem 830 (or in other instances, such as shown in FIG. 8C, the stem 830 may be magnetized to act as the second magnet).

The magnet assembly is configured such that first magnet 832 is attracted to the second magnet. The stem 830 may have a first portion 830a and a second portion 830b, where the second portion 830b is stiffer than the first portion 830a (e.g., due to different material selection and/or the first portion 830a being thinner than the second portion 830b). When the button 826 is moved from a neutral position along one of the first set of directions 814, the stem may preferentially bend along the first portion 830a of the stem. The resistance to bending may increase as the first portion 830a deviates from the neutral position. As the stem 830 approaches the first magnet 832, the attractive force between the stem 830 and the first magnet 832 increases.

The magnet assembly may be configured such that initially the resistance to bending of the first portion 830a of the stem 830 increases at a faster rate than the attractive force increases, such that over a first portion of the stroke the overall resistance to movement increases. The magnet assembly may be further configured that, at a certain point, the attractive force starts to increase faster than the resistance to bending increases, such that over a second portion of the stroke the overall resistance to movement decreases. Eventually the first magnet 832 will contact a stationary portion of the input device 824 (e.g., preferably the first magnet 832, though it may be any stationary portion). At this point, the first portion 830a may be prevented from bending any further, and any further bending occurs in the second portion 830b of the stem. This results in an increased resistance to further bending, and an overall resistance profile that may be tailored similar to the embodiments discussed in FIGS. 8A and 8B.

The input device 824 may be configured to register a translational input at a desired point along the stroke of the button 826, preferably when the stem 830 contacts the first magnet 832. This contact may be detected using any suitable switch or switch assembly such as described in more detail above. When the button 826 is no longer being pressed by a user, the stem 830 may bias the button 826 back to the neutral position.

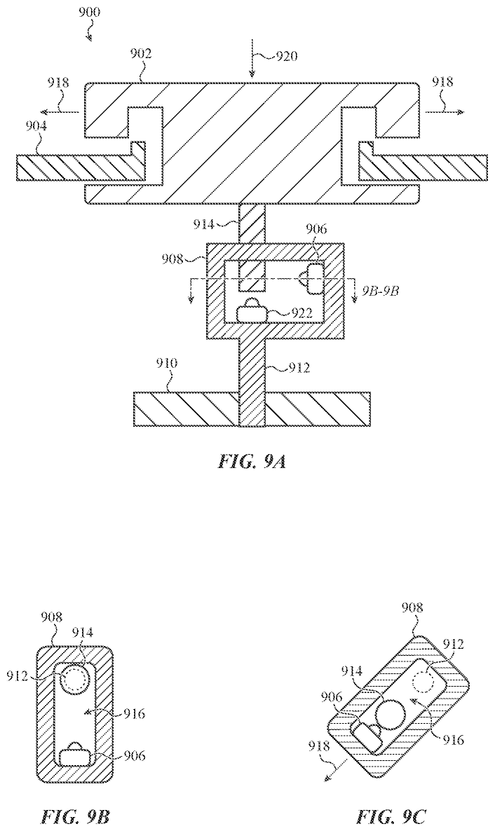

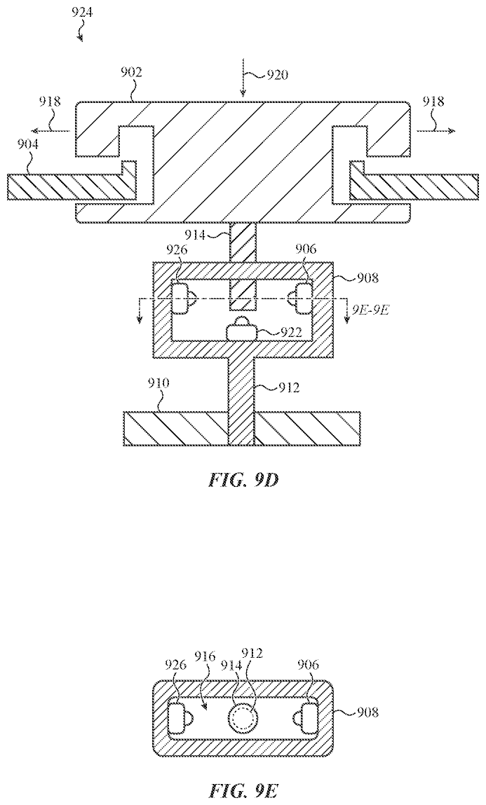

In some variations of the input devices described here, the input devices may include a button and a switch assembly that comprises a rotatable linkage and a switch. The button is slidably coupled (and in some variations rotatably coupled) to the rotatable linkage and the rotatable linkage is rotatably coupled to a stationary component, such that movement of the button along any of a first set of different directions causes the linkage to rotate to align with that direction and actuates the switch. For example, FIGS. 9A and 9B-9C show a cross-sectional side view and cross-sectional top views respectively of one such variation of an input device 900. As shown there, the input device 900 comprises a button 902, a housing 904, and a switch assembly comprising a first switch 906 and a rotatable linkage 908. The button 902 is configured to move in a first set of different directions 918 (such as described above with respect to FIGS. 2A-2E and 3) to register a translational input. The button 902 may optionally be further configured to move in an additional direction 920 perpendicular to the first set of different directions 918 (e.g., to register a translational input) and/or rotate around a rotational axis parallel to the additional direction 920 (e.g., to register a rotational input).

The rotatable linkage 908 is rotatably coupled to a stationary component 910 (which may be any physical structure that is held or otherwise placed in a fixed position relative to the housing 904 as discussed above) at a pivot point 912 (which is shown with a dashed line in FIGS. 9B and 9C), and the button 902 is slidably coupled with the rotatable linkage 908. Specifically, the button 902 comprises a post 914 slidably positioned within a track 916 that is defined in the rotatable linkage 908. The post 914 is slidable within the track 916 to slidably couple the button 902 to the rotatable linkage 908. Additionally, the post 914 may be able to rotate within the track 916 to allow the button 902 to rotate around a rotation axis (e.g., parallel to additional direction 920) to register a rotational input without otherwise impacting the operation of the switch assembly.

When the button 902 is in a neutral position, the post 914 may be at a first position within the track 916 (e.g., aligned with the pivot point 912 such as shown in FIGS. 9B and 9C). As the button 902 is moved along any of the first set of different directions 918, the post 914 may slide to a second position within the track 916, as shown in FIG. 9C. If the track 916 is not already aligned with this direction 918, the rotatable linkage 908 will rotate around pivot point 912 to align the track 916 with the direction of motion, thereby allowing the first switch 906 to be actuated as that post 914 is slid to the second position regardless of which of the first set of different directions 918 the button 902 is moved along.

The first switch 906 may detect that the post 914 has reached the second position using any proximity, contact, and/or force sensing techniques as described above. For example, in the variation shown in FIGS. 9A-9C, the switch 906 may comprise a tactile switch that is positioned in the track 916 at a first end of the track 916. As the post 914 slides within the track 916 to the second position, the post 914 may contact and depress a button of the tactile switch to actuate the switch 906 and register a translational input. Additionally, when the button 902 is configured to be moved in the additional direction 920, the switch assembly may optionally further comprise a second switch 922 configured to detect movement of the post in that direction.

In some variations, the rotatable linkage may comprise two switches configured to detect movement of the post 914 within the track 916. FIGS. 9D and 9E show cross-sectional side and top views, respectively, of another variation of an input device 924. Input device 924 is configured and labeled the same as the input device 900 of FIGS. 9A-9C, except that the switch assembly comprises a first switch 906 and a second switch 926, where at least one of which is actuated when the button 902 is moved in any of the first set of directions 918. The first switch 906 is positioned at a first end of the track 916 and the second switch 926 is positioned at a second end of the track 916. When the button 902 is in a neutral position, the post 914 may be at a first position within the track 916 (e.g., aligned with the pivot point 912 such as shown in FIGS. 9D and 9E).

When the button 902 is moved along one of the first set of different directions, the post 914 will either slide toward the first end or the second end (depending on the direction and the initial orientation of the rotatable linkage 908), and the rotatable linkage 908 may rotate (if needed) to align the track 916 with the direction of movement of the post 914. If the post 914 slides towards the first end, the first switch 906 is configured to actuate when the post 914 reaches a second position at or near the first end of the track. Conversely, if the post 914 slides toward the second end, the second switch 926 is configured to actuate when the post 914 reaches a third position at or near the second end of the track. This may reduce the amount of rotation that the rotatable linkage 908 may need to rotate (and/or the force required to rotate the rotatable linkage 908) in order to align the track 916 with the direction of motion.

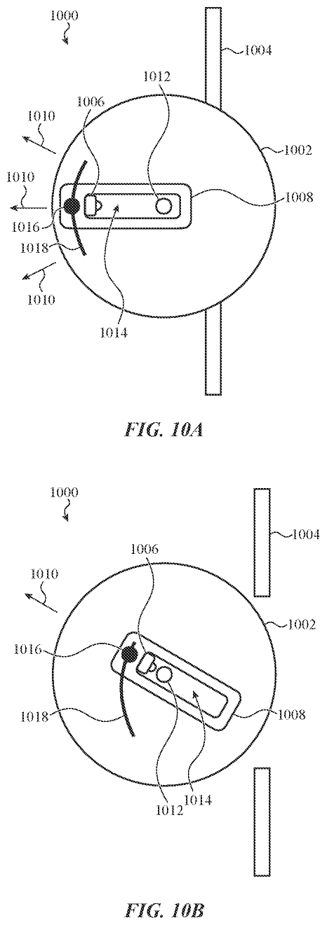

While the rotatable linkage 908 is shown in FIGS. 9A-9E as being translationally fixed to a stationary component 910 at pivot point 912 (i.e., the rotatable linkage 908 may rotate at pivot point 912, but may not translate relative to pivot point 912), in other variations, the pivot point 912 may be able to translate relative to the stationary component. For example, FIGS. 10A and 10B show cross-sectional side views of one such variation of an input device 1000. As shown there, the input device 1000 comprises a button 1002, a housing 1004, and a switch assembly comprising a switch 1006 and a rotatable linkage 1008. The button 1002 is configured to move in a first set of different directions 1010 (such as described above with respect to FIGS. 2A-2E and 3) to register a translational input. The button 1002 may optionally be further configured to move in an additional direction (not shown) perpendicular to the first set of different directions 1010 (e.g., to register a translational input) and/or rotate around a rotational axis parallel to the additional direction (e.g., to register a rotational input).

As shown there, the button 1002 is slidably coupled (and in some instances rotatably coupled) to the rotatable linkage 1008. For example, the button 1002 comprises a first post 1012 slidably positioned within a first track 1014 that is defined in the rotatable linkage 1008. The first post 1012 may be able to rotate within the track 1014 to allow the button 1002 to rotate around a rotational axis to register a rotational input without otherwise impacting the operation of the switch assembly. The rotatable linkage 1008 in turn may be rotationally and translationally coupled to a stationary component (not shown, which may be any physical structure that is held or otherwise placed in a fixed position relative to the housing 1004 as discussed above). Specifically, the rotatable linkage 1008 may comprise a second post 1016 (which may act as a pivot point as discussed above) that is slidably positioned within a second track 1018 defined in the stationary component. The second post 1016 may slide and/or rotate within the second track 1018 to allow the rotatable linkage 1008 to slide and/or rotate, respectively, relative to the stationary component.

For example, when the button 1002 is in a neutral position as shown in FIG. 10A, the first post 1012 may be at a first position within the first track 1014 (e.g., positioned at or near a first end of the first track 1014) and the second post 1016 may be at a corresponding first position within the second track 1018. At the button 1002 is moved along any of the first set of different directions 1010, the first post 1012 may slide to a second position within the first track 1014 (e.g., at or near a second end of the first track 1014), as shown in FIG. 10B. If the first track 1014 is not already aligned with this direction 1010, the rotatable linkage 1008 will rotate around the second post 1016 and the second post 1016 will slide along the second track 1018 to a corresponding second position, to allow the first track 1014 to align with this direction 1010. This allows the switch 1006 to be actuated as that first post 1012 is slid to the second position regardless of which of the first set of different directions 1010 that the button 1002 is moved along.

The switch 1006 may detect that the first post 1012 has reached the second position using any proximity, contact, and/or force sensing techniques as described above. For example, in the variation shown in FIGS. 10A and 10B, the switch 1006 may comprise a tactile switch that is positioned in the first track 1014 at or near the second end of the first track 1014. As the first post 1012 slides within the first track 1014 to the second position, the first post 1012 may contact and depress a button of the tactile switch to actuate the switch 1006 and register a translational input.

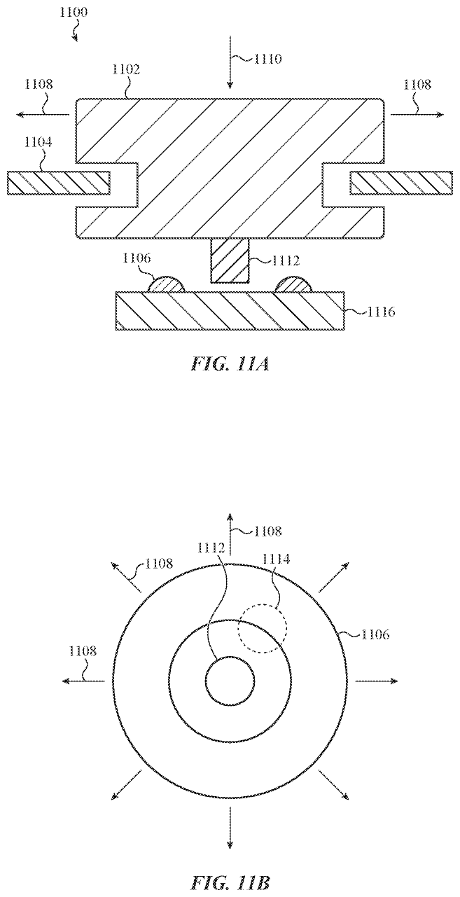

In some variations, the input devices described herein may comprise a button and an annular dome switch that is actuated as the button is moved in any of a first set of different directions. FIGS. 11A and 11B show a cross-sectional side view and a cross-sectional top view, respectively, of one such variation of an input device 1100. As shown there, input device 1100 comprises a button 1102, a housing 1104, and an annular dome switch 1106. The button 1102 is configured to move in a first set of different directions 1108 (such as described above with respect to FIGS. 2A-2E and 3) to register a translational input. The button 1102 may optionally be further configured to move in an additional direction 1110 perpendicular to the first set of different directions 1108 (e.g., to register a translational input) and/or rotate around a rotational axis parallel to the additional direction 1110 (e.g., to register a rotational input). The annular dome switch 1106 may be connected to a stationary component 1116 such as described in more detail above.

The input device 1100 may be configured such that a portion of the button 1102 engages the annular dome switch 1106 when the button 1102 is moved in any of the first set of different directions 1108. For example, the button 1102 may comprise a post 1112 that extends past a top surface of the annular dome switch 1106 along the additional direction 1110. When the button 1102 moves along any of the first set of different directions 1108, the post 1112 also moves along that direction until it contacts the annular dome switch 1106 (as shown, for example, by dashed line 1114). This contact in turn depresses a portion of the annular dome switch 1106 to actuate the switch (and thus register a translational input). For example, depression of the annular dome switch 1106 may cause a first electrical contact within the annular dome switch 1106 to contact a second electrical contact within the annular dome switch 1106 to complete an electrical circuit (which may be identified to register the first translational input).

The annular dome switch 1106 is preferably circular, although it should be appreciated that the annular dome switch 1106 may be configured in any other suitable polygonal shape. Additionally or alternatively, the annular dome switch 1106 may comprise multiple individual dome switches arranged in a circle or another polygonal shape, any of which may be individually depressed to register a translational input as the button 1102 (and with it the post 1112) is moved in any of the first set of different directions 1108. The annular dome switch 1106 may comprise a set of slits defined therethrough which may selectively adjust the resistance of the annular dome switch 1106 to being depressed by the post 1112. In variations where the button 1102 is configured to move along an additional direction 1110 to register a translational input, the input device 1100 may further comprise an additional switch (not shown) configured to actuate when the button 1102 has been sufficiently moved along the additional direction 1110.

It should be appreciated that the input devices described here may include a plurality of different switch assemblies, each of which registers a translational input when a button is moved in a different set of different directions. For example, an input device may include a first switch assembly with a first switch that is actuated when the button is moved along any of a first set of different directions. The input device may further include a second switch assembly with a second switch that is actuated when the button is moved along any of a second set of different directions. As one non-limiting example, an input device may include two switch assemblies, each of which comprises a rotatable member such as those described above with respect to FIGS. 4A and 4B.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings. Also, when used herein to refer to positions of components, the terms above and below, or their synonyms, do not necessarily refer to an absolute position relative to an external reference, but instead refer to the relative position of components with reference to the figures.

What is claimed is:

1. An input device comprising:
a housing;
a button moveable relative to the housing in a first set of different directions; and
a switch assembly comprising:
a cavity surface defining a cavity; and
a first switch;
wherein the movement of the button in any of the first set of different directions creates relative movement between the cavity surface and the first switch, thereby actuating the first switch and registering a first translational input.

2. The input device of claim 1 wherein the button is moveable relative to the housing in an additional direction that is perpendicular to the first set of different directions.

3. The input device of claim 1 wherein the first switch is a tactile switch.

4. The input device of claim 1 wherein:
the switch assembly further comprises an intermediate component positioned between the cavity surface and the first switch, and
the switch assembly is configured such that the relative movement between the cavity surface and the first switch moves the intermediate component toward the first switch.

5. The input device of claim 4 further comprises a stationary component; and
wherein the intermediate component is constrained to move in a single direction relative to the stationary component.

6. The input device of claim 4 wherein the intermediate component is a magnetic intermediate component.

7. The input device of claim 1, wherein the switch assembly is configured such that the first switch pivots during the relative movement between the cavity surface and the first switch.

8. The input device of claim 7, wherein:
the cavity surface comprises a first magnet arrangement and the first switch comprises a second magnet arrangement; and
the first magnet arrangement attracted is attracted to the second magnet arrangement during the relative movement between the cavity surface and the first switch.

9. An input device comprising:
a housing;
a button moveable relative to the housing in a first set of different directions; and
a switch assembly comprising:
a rotatable member; and
at least one switch; wherein:
the rotatable member is rotatable and translatable relative to a pivot point; and
the switch assembly is configured such that the movement of the button in any of the first set of different directions causes the rotatable member to move relative to the pivot point, thereby actuating the at least one switch.

10. The input device of claim 9 wherein the at least one switch comprises multiple switches.

11. The input device of claim 10 wherein:
the multiple switches comprise:
a first switch; and
a second switch; and
the switch assembly is configured such that:
the first switch is actuated when the rotatable member translates toward the first switch; and
the second switch is actuated when the rotatable member rotates in a first direction.

12. The input device of claim 9, wherein the switch assembly comprises one or more springs connecting the rotatable member to a stationary component.

13. The input device of claim 9, wherein:
the rotatable member comprises a proximal contact surface facing the button; and
the movement of the button in any of the first set of different directions causes the button to apply a force to the proximal contact surface.

14. The input device of claim 9, wherein:
the button is rotatable around a rotational axis;
the input device registers a rotational input when the button rotates around the rotational axis; and
the first rotational axis is perpendicular to the first set of different directions.

15. An input device comprising:
a housing;
a button moveable relative to the housing in a first set of different directions; and
a switch assembly comprising:
a rotatable linkage; and
a set of switches; wherein:
the button is slidably coupled to the rotatable linkage; and
the movement of the button in any of the first set of different directions moves the button relative to the rotatable linkage, thereby actuating at least one switch of the set of switches.

16. The input device of claim 15, wherein the rotatable linkage is rotatable around a pivot point.

17. The input device of claim 16, wherein the pivot point is slidable relative to a stationary component of the input device.

18. The input device of claim 15, wherein the button comprises a post that is slidably positioned within a first track defined in the rotatable linkage.

19. The input device of claim 18, wherein the set of switches comprises a first switch positioned in the first track.

20. The input device of claim 19, wherein the at least one switch further comprises a second switch positioned in the first track.
